(19) United States
(12) Patent Application Publication
(10) Pub. No.: US 2013/0178269 A1
(43) Pub. Date: Jul. 11, 2013

(54) SECOND CHANCE GAMING SYSTEMS, METHODS, APPARATUS AND COMPUTER-READABLE MEDIA

(71) Applicants: Gary SHAW, Gibraltar (GI); Richard Sagman, Gibraltar (GI); Joel Caplin, San Francisco, CA (US)

(72) Inventors: Gary SHAW, Gibraltar (GI); Richard Sagman, Gibraltar (GI); Joel Caplin, San Francisco, CA (US)

(73) Assignee: Nektan Limited

(21) Appl. No.: 13/586,349

(22) Filed: Aug. 15, 2012

Related U.S. Application Data
(60) Provisional application No. 61/525,510, filed on Aug. 19, 2011.

(51) Int. Cl. A63F 13/00; A63F 1/00

(52) U.S. Cl. CPC A63F 13/00; A63F 1/00
USPC 463/16; 273/138.1

(57) ABSTRACT

A gaming method, machine and system provide a 2^{nd} chance draw (S135). The gaming method according to one embodiment provides to a player one or more second chance games based on participation in a first game of chance; determines at least one benefit to be awarded to the player upon participation in the one or more second chance games; and reveals to the player the at least one benefit, wherein the method allows for entering the player into the one or more second chance games in the providing step.

### CROSS REFERENCE TO RELATED APPLICATION

This non-provisional application claims priority under 35 U.S.C. §119(e) to U.S. Provisional Application No. 61/525,510 filed on Aug. 19, 2011, the entire contents of which are hereby incorporated by reference.

### BACKGROUND OF THE INVENTION

1. Field of the Invention

The present invention is directed to systems, methods, apparatuses and computer-readable media related to gaming, and more particularly, to second (2^{nd}) chance opportunities within various gaming platforms.

2. Description of the Related Art

Lottery games are ubiquitous and highly popular. In a lottery, a few winning tickets receive all the prizes, while the vast majority of acquired lottery tickets end up having a zero win. This reduces the popularity of lottery games, as it provides no rewards for a large number of players who bought such non-winning tickets.

To improve winning prospects, lotteries implement 2^{nd} chance draws, which are tools uses to increase ticket sales, help maintain brand interaction with their players, and increase the longevity of lottery scratch cards that are on sale. Having a 2^{nd} chance draw for a non-winning ticket can bring back the original value of the ticket, and allows players to win even more prizes, thus increasing the overall popularity of the lottery. A 2^{nd} chance draw in related art is purely a game of chance which provides a totally random result for a 2^{nd} chance draw. In some systems, losing players can use their losing lottery tickets to enter one or more additional lotteries at no additional cost, like a replay program. Players may use their losing lottery tickets to enter an additional lottery and to use points assigned to their losing lottery tickets to enter additional lotteries.

### SUMMARY OF THE INVENTION

Disclosed embodiments of the present invention provide more than just a random drawing, by providing additional elements to a 2^{nd} chance draw. Disclosed embodiments of this application include systems, methods, apparatuses and computer-readable media and data structures which relate to 2^{nd} chance opportunities within various gaming platforms, and which may be implemented in any computing device and platform, across various types of networks, and in any online or physical gaming venue. Disclosed embodiments of this application may be implemented as products for the online gaming environment or in-person/live gaming environment.

The 2^{nd} chance draw of the present invention may use randomly generated multipliers on ticket entry to modify both the number of draw entries and the loyalty points awarded to players. The 2^{nd} chance draw of the present invention may also use n-permutation draw configurations, and may buy into cash and prize drawings with loyalty points or other prizes awarded from 2^{nd} chance draws. The 2^{nd} chance draw of the present invention may also include a skill component in connection with the 2^{nd} chance draw. Furthermore, gaming activity that is not part of a 2^{nd} chance draw can award multipliers to a future 2^{nd} chance entry.

The 2^{nd} chance draw may be implemented in a draw engine that is fully automated from end-to-end, communicates between jurisdictions concerning 2^{nd} draw submissions on its interface, and integrates with any 3^{rd} party player management system, loyalty engine, or other award system, via a secure Application Programming Interface (API).

The present invention is directed to gaming methods, apparatuses and systems. According to a first aspect of the present invention, a gaming method comprises: providing to a player one or more second chance games based on participation in a first game of chance; determining at least one benefit to be awarded to the player upon participation in the one or more second chance games; and revealing to the player the at least one benefit, wherein the method allows for entering the player into the one or more second chance games in the providing step.

According to a second aspect of the present invention, a gaming machine comprises: at least one processor, wherein the at least one processor provides to a player one or more second chance games based on participation in a first game of chance, determines at least one benefit to be awarded to the player upon participating in the one or more second chance games, and reveals to the player the at least one benefit, wherein the at least one processor allows for entering the player into the one or more second chance games.

According to a third aspect of the present invention, a gaming system comprises: an engine for playing one or more second chance games; a first connector device for interfacing between the engine and a device of a player; and a second connector device for interfacing between the engine and a 3^{rd} party system, the 3^{rd} party system being configured to manage at least one of participation in the one or more second chance games and benefits to be awarded for playing the one or more second chance games, wherein the engine and connector devices are programmed to operate so that: the engine provides to the player one or more second chance games based on participation in a first game of chance, and determines at least one benefit to be awarded to the player upon participating in the one or more second chance games, the first connector device enables the player to enter the one or more second chance games, and the second connector device integrates the engine with the 3^{rd} party system.

### BRIEF DESCRIPTION OF THE DRAWINGS

Further aspects and advantages of the present invention will become apparent upon reading the following detailed description in conjunction with the accompanying drawings. The accompanying drawings, which are incorporated in and constitute a part of this specification, illustrate several embodiments of the invention and together with the description, serve to explain the principles, features and aspects of the invention.

It may be appreciated that the diagrams are examples of the system environment and the components within the apparatuses of the present invention, and the information depicted therein may be configured in a different manner, as may be appreciated by one skilled in the art.

FIG. 1 is a general block diagram of a system environment in which a 2^{nd} chance draw may be played according to an embodiment of the present invention;

FIG. 2 is an exemplary block diagram of an engine that may be implemented in the system environment in which a 2^{nd} chance draw may be played, according to an embodiment of the present invention illustrated in FIG. 1;

FIG. 3 is an exemplary block diagram illustrating components included in a client device capable of performing a 2^{nd} chance draw, according to an embodiment of the present invention illustrated in FIG. 1;

FIG. 4A is a general flow diagram illustrating a process flow for a 2^{nd} chance draw flow, according to an embodiment of the present invention;

FIG. 4B is a flow diagram illustrating the beginning of a 2^{nd} chance draw, according to an embodiment of the present invention;

FIG. 4C is a general flow diagram illustrating additional details of a 2^{nd} chance draw, according to an embodiment of the present invention;

FIG. 5A is a flow diagram illustrating in more detail a process flow for a 2^{nd} chance draw flow, according to an embodiment of the present invention;

FIG. 5B is a flow diagram illustrating in more detail a process flow for a 2^{nd} chance draw flow including recursive gaming loops, according to an embodiment of the present invention;

FIG. 6 is a flow diagram illustrating in more detail a process flow for a 2^{nd} chance draw in which a platform cross-checks a ticket number with an encrypted ticket database from a lottery, according to an embodiment of the present invention;

FIG. 7 is a flow diagram illustrating a process flow for a 2^{nd} chance draw in which a lottery's encrypted validation process is not used and the ticket number is allowed to be recorded and processed on the platform, according to an embodiment of the present invention;

FIG. 8 is a flow diagram illustrating an exemplary 2^{nd} chance draw process in which players win cash, according to an embodiment of the present invention;

FIG. 9 is a flow diagram illustrating an exemplary 2^{nd} chance draw process flow in which players win sponsored prizes, according to an embodiment of the present invention;

FIG. 10 is a flow diagram illustrating an exemplary 2^{nd} chance draw process flow in which players win loyalty points, according to an embodiment of the present invention;

FIG. 11 is a flow diagram illustrating an exemplary 2^{nd} chance draw process flow in which players win lottery products, according to an embodiment of the present invention;

FIG. 12 is a flow diagram illustrating an exemplary 2^{nd} chance draw process flow in which players win cash play entries, according to an embodiment of the present invention;

FIG. 13A illustrates an exemplary back office report produced for history records, and FIG. 13B illustrates an exemplary history version which may be used for main lottery sites, according to an embodiment of the present invention;

FIG. 14A illustrates an exemplary screen shot by which an RNG process is started to determine a player's multiplier and determine benefits received by a ticket entry in a 2^{nd} chance draw, according to an embodiment of the present invention;

FIG. 14B illustrates an exemplary screen shot by which benefits are revealed to the player after a multiplier is revealed, according to an embodiment of the present invention illustrated in FIG. 14A;

FIG. 15 is a flow diagram illustrating a flow of a 2^{nd} draw process using an RNG multiplier, according to an embodiment of the present invention;

FIG. 16 illustrates an exemplary screen shot in which a user can review the odds for a 2^{nd} chance draw before playing the draw, according to an embodiment of the present invention;

FIG. 17 is a flow diagram illustrating a process flow of a 2^{nd} chance draw in which players can use loyalty points to purchase entry into designated 2^{nd} chance draws, according to an embodiment of the present invention;

FIG. 18 is a block diagram illustrating a 2^{nd} chance engine integrated with external systems, according to an embodiment of the present invention;

FIG. 19A illustrates a straight-through draw machine workflow for draw management in a 2^{nd} chance engine according to an embodiment of the present invention;

FIG. 19B illustrates a manual draw machine workflow for draw management in a 2^{nd} chance engine according to an embodiment of the present invention; and

FIG. 19C illustrates in more detail a machine workflow for draw management in a 2^{nd} chance engine according to an embodiment of the present invention.

### DETAILED DESCRIPTION

Second chance draws are tools that lotteries use to increase ticket sales, help maintain brand interaction with their players and increase the longevity of scratch cards that are on sale. For example, if a lottery rolls out a scratch card with a top prize of $200,000, which is won on the second day, the value of the draw will be lost and the game will lose popularity. Having a 2^{nd} chance draw can bring back this value as it will allow players to continue to purchase tickets to win even more prizes.

The present invention discloses systems, methods, apparatuses and computer-readable media related to 2^{nd} chance opportunities within various gaming platforms, and which may be implemented in any computing device and platform, across various types of networks, and in any online or physical gaming establishment. The present invention implements 2^{nd} chance play environments beyond traditional standard 2^{nd} chance draw mechanisms, to provide unique processes and features which further enhance players' experience when entering their tickets.

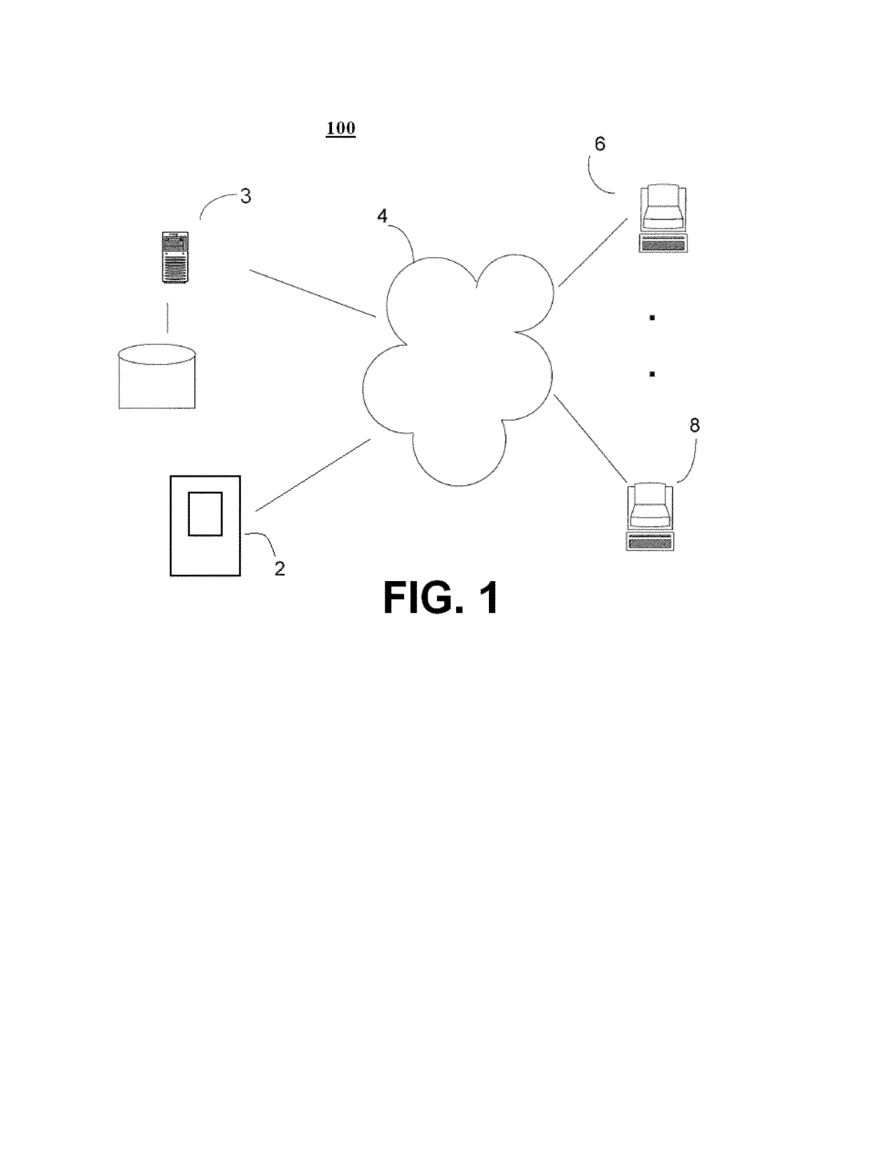

Aspects of the invention are more specifically set forth in the accompanying description with reference to the appended figures. FIG. 1 is a general block diagram of a system environment in which a 2^{nd} chance draw may be played according to an embodiment of the present invention. The system architecture illustrated in FIG. 1 depicts a system environment in which systems, methods, apparatuses, computer-readable media and data structures consistent with the principles of some embodiments of the present disclosure may be included. It may be appreciated that the components of system 100 may be implemented through any suitable combinations of hardware, software, and/or firmware.

As shown in FIG. 1, system 100 includes at least one engine 2 and/or at least one external database/application system 3. Engine 2 and external database/application system 3 may be communicably linked to one or more client devices 6, 8, etc., through network 4. The external database/applications system 3 may be any type of physical or virtual unit on which games, gaming applications such as, for example, loyalty programs, 3^{rd} party platforms, databases of prizes, lottery applications, reward centers, etc. reside. External database/applications system 3 may be a machine in a gaming venue, a lottery machine, an electronic system, a gaming platform, a server, a virtual application on a website, etc. Engine 2 is configured to allow 2^{nd} chance play. Engine 2 may be a physical machine, a server, a virtual application, a gaming platform, a software package, etc.

Network 4 may be implemented as the Internet, or any local or wide area network, either public or private. Network 4 may also be a hardware system physically connecting some or all of the engine 2 and client devices 6, 8. Client devices 6, 8 may be implemented as any computing devices such as a personal computing device, a server, a server network, handheld computing device, slot machine, other gaming machine in a gaming venue, lottery machine, an interface in a virtual environment, etc.

It may be appreciated by one of ordinary skill in the art that while only one engine, one external database/applications system, one network and two client devices are depicted, more or fewer engines, external database/applications systems, networks and client devices and/or other devices may reside within system 100.

The elements inside system 100 may include one or more (micro)processors, purpose built hardware such as, for example, FPGA, ASIC, etc., software systems and applications, software packages, mechanical and electrical parts, servers, etc. Software packages that may be part of engine 2, external database/applications system 3, network 4 and client devices 6, 8 may be recorded on a computer readable medium such as a memory device, RAM, CD/DVD/USB drives, handheld memory device, etc., and/or may be part of a physical device such as one or more (micro)processors or electro-mechanical systems. Any of engine 2, external database/applications system 3, network 4, and client devices 6, 8 may be fixed systems, mobile systems or portable systems. It may be appreciated that various configurations may be implemented providing the functionality discussed herein below is achieved.

Although the various components of FIG. 1 are illustrated as discrete elements, it should be recognized that certain operations of some of the various components may be performed by the same physical device, e.g., by one or more (micro)processors or other type of devices.

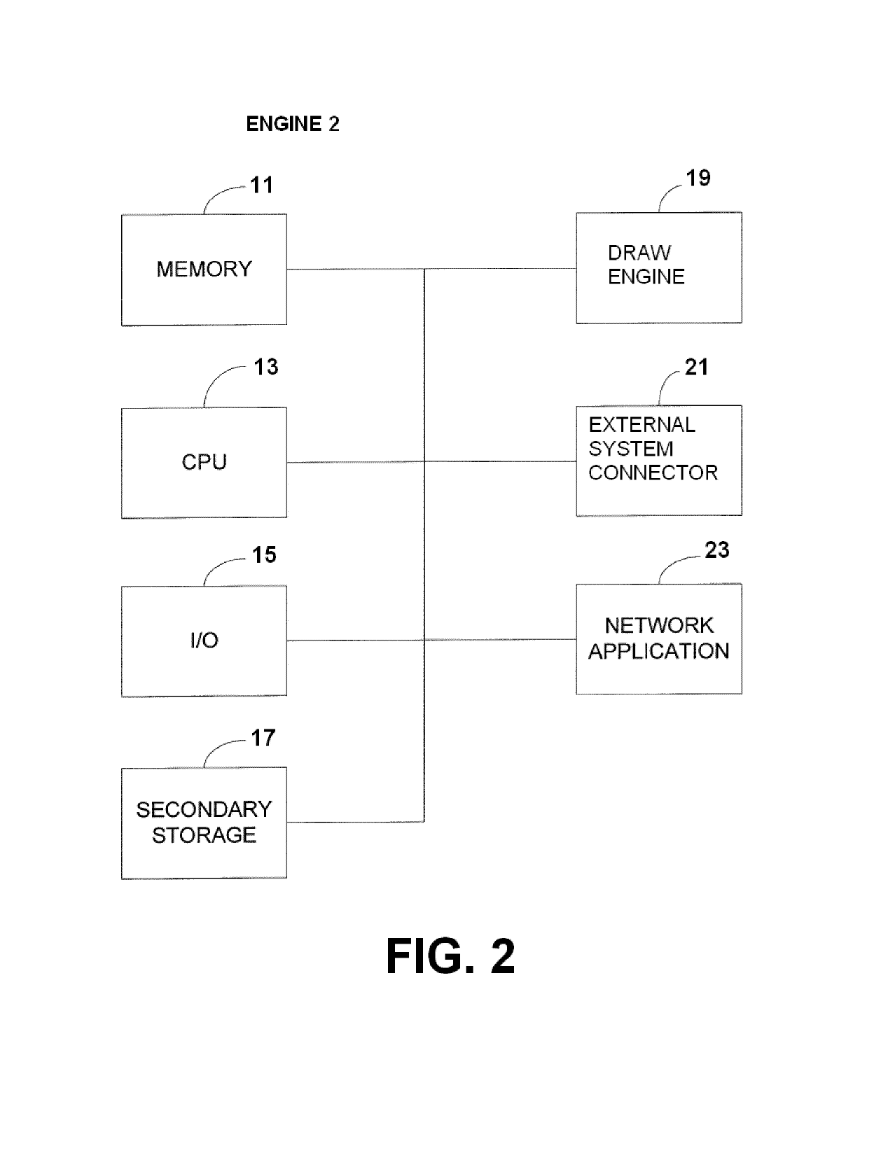

FIG. 2 illustrates an exemplary block diagram of an engine 2 that may be implemented in the system environment 100 in which a 2^{nd} chance draw may be played according to an embodiment of the present invention. As shown in FIG. 2, engine 2 may include a CPU 13, network application 23, memory 11, secondary storage 17, input/output devices 15, a draw engine 19 and an external system connector 21.

Input/output devices 15 may include, for example, a keyboard, a mouse, a video cam, a display, an interactive screen, a storage device, a printer, a portable recording medium, an electro-mechanical device, etc. Network application 23 may include software applications that facilitate communication with client devices 6, 8 through network 4. It may be appreciated by one of ordinary skill in the art that while only certain components are depicted, other components may be included within engine 2. Also, some of the components shown in FIG. 2 may be absent from engine 2.

Draw engine 19 may be implemented as a game server, a lottery application, a virtual interface, a website, an in-venue device, etc., to facilitate establishing, maintaining and closing sessions with client device 6, 8 wherein a 2^{nd} chance draw may be exercised. Draw engine 19 may also be an application in an operator-run facility, through which players can enter 2^{nd} chance codes. Draw engine 19 may further communicate with any of the other components of engine 2 in order to send and receive information regarding existing sessions of 2^{nd} chance draws. Draw engine 19 may further implement games which are not directed to, or solely directed to 2^{nd} chance draws. Draw engine 19 may additionally include components for implementing or modifying characteristics of 2^{nd} chance draw games and game outcomes in real-time or off-line, and for implementing security operations. Draw engine 19 may also be implemented to receive information regarding a game and parse the game down to one or more levels, parse a full version of the game down to a specified time period, etc., in order to implement a portion of the game in connection with a 2^{nd} chance draw. The parsed down version may appreciate all of the features of the full version of the game, except that only one or more levels are presented, the game is only played for a particular period of time, etc. The draw engine 19 may implement any game as the game played during the 2^{nd} chance draw. Alternatively, draw engine 19 may connect to network 4 to a gaming platform, or to download a certain game.

Memory 11 and/or secondary storage 17 may record, store, send, receive, and/or process player information, play information, and information regarding existing sessions of draws.

External system connector 21 may be implemented as a communication interface with external database/applications system 3, for communicating wins (or absence of a win), prize awards and types of awards thereof, lottery results, reward information, loyalty points information, etc., for a player which has played a 2^{nd} chance draw and has (or has not) won something.

I/O unit 15 may communicate/interface with client devices 6, 8 and thus with end-users, using hardware, software and hybrid interfaces that can communicate and exchange information with computers, mobile devices, a network, an in-venue game machine, etc.

Although the various components of FIG. 2 are illustrated as discrete elements, it should be recognized that certain operations of some of the various components may be performed by the same physical device, e.g., by one or more (micro)processors or other type of devices. Thus, it may be appreciated that the various components of engine 2 may reside in or work from the same unit, computing device, or (micro)processor. Various components of engine 2 may also be separate. For example, the draw engine 19 and the external system connector 21 may reside on, or work from, separate computing devices, units or (micro)processors. It may further be appreciated that the draw engine 19 may communicate with more than one game engine or platform that resides within the same computing device or on different computing devices or remote servers operating within system environment 100.

The external database/applications system 3 may similarly include game engines, skill and non-skill game engines, slot machine applications, etc., to facilitate establishing, maintaining and closing sessions with client device 6, 8 wherein a 2^{nd} chance draw is played. Like engine 2, the external database/applications system 3 may include components to facilitate receiving information regarding an existing 2^{nd} chance draw session, implement a portion of a game and pass information regarding the results of the portion of the game back to the engine 2.

Alternatively, engine 2 and/or external database/applications system 3 for connecting to engine 2 may be accessed directly by a player in a gaming venue, lottery establishment, etc. The engine 2 and external database/applications system 3 may, for example, be electro-mechanical units in a gaming venue, and may include electronic components for communication with network 4, and/or interface components to provide direct accessibility to players.

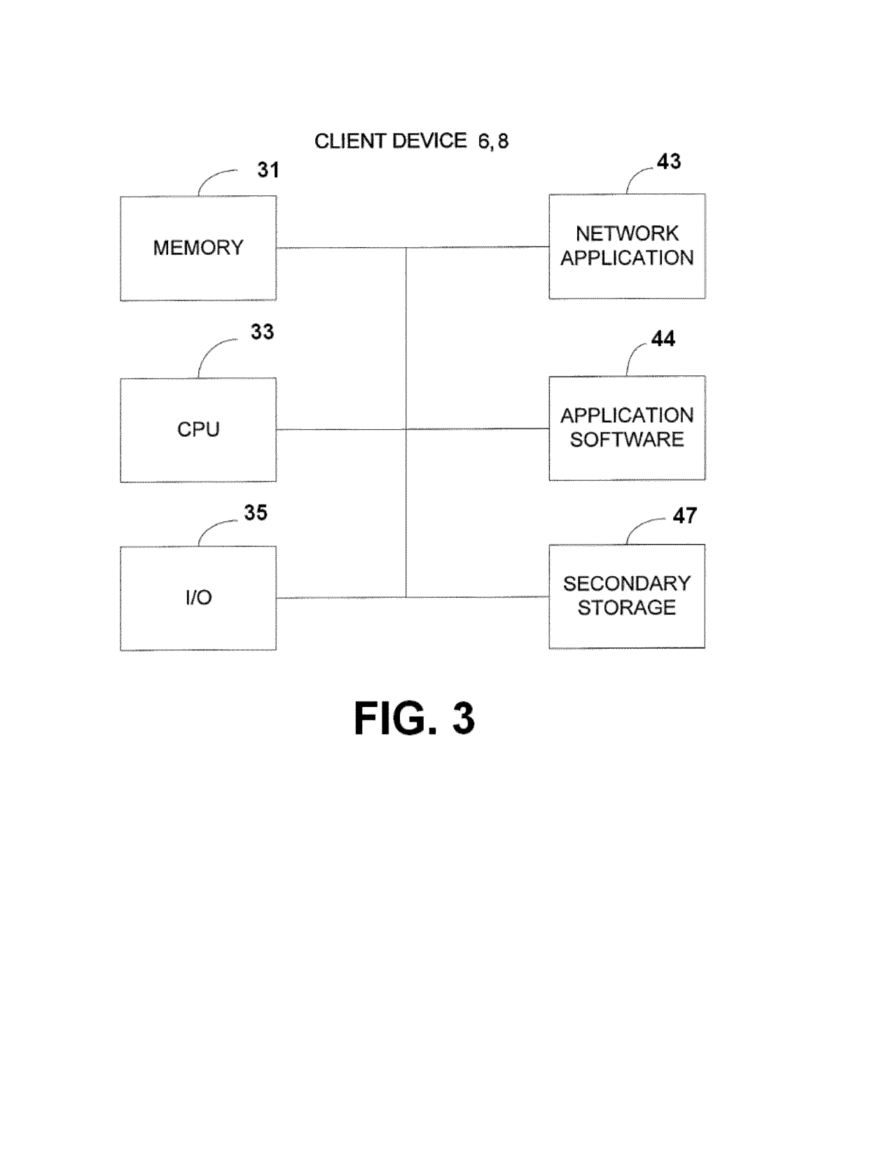

FIG. 3 is an exemplary block diagram illustrating components included in a client device 6, 8 capable of performing a 2^{nd} chance draw, according to an embodiment of the present invention illustrated in FIG. 1. Client device 6, 8 may include central processing unit 33, input/output devices 35, application software 44, memory 31, secondary storage 47, and network application 43. Client device 6, 8 may be communicably linked to engine 2 and/or external database/applications system 3 through network 4. Client device 6, 8 may also be communicably linked to engine 2 and/or external database/applications system 3 through hardware. It may be appreciated by one of ordinary skill in the art that while only certain components are depicted, other components may be included within client device 6, 8. Also, some components shown in FIG. 3 may be absent from client device 6, 8.

A player may access engine 2 or external database/applications system 3 through network 4 using network application 43 wherein the software may include a browser including browser applications available from, e.g., Microsoft, Mozilla, Netscape, etc., other software for connecting to an item/page/interface/application package, etc. available on the network, a connector to, e.g., HTTP, SMS, etc. Application software 44 may include software for facilitating creation of a session between the client device and the game engine/platform, in order to enter a 2^{nd} chance draw as discussed herein. Secondary storage 47 may be used to store information regarding players, game information such as preferences, scores, etc., configuration for client device or engine 2/external database/applications system 3/network 4, ticket information for a 2^{nd} chance draws, previous wins or preferences for prizes, etc. Secondary storage 47 may include a computer readable medium such as a memory device, RAM, CD/DVD/USB drives, etc., and/or a unit on a physical device such as one or more (micro)processors.

Input/output devices 35 may include, for example, a keyboard, a mouse, a video cam, a display, a touch-screen display, a storage device, a printer, a portable recording medium, an electro-mechanical device, etc.

Although the various components of FIG. 3 are illustrated as discrete elements, such an illustration is for ease of explanation and it should be recognized that certain operations of the various components may be performed by the same physical device, e.g., by one or more (micro)processors or other kind of device. The various components of FIG. 3 may include one or more (micro)processors, purpose built hardware such as, for example, FPGA, ASIC, etc., software systems and applications, software packages, etc., as well as a computer readable medium such as a memory device, RAM, CD/DVD/USB drives, etc., storing software packages.

Embodiments of the present invention may be implemented in any computing device and platform, and across various types of networks. In an exemplary implementation, embodiments of the present invention may be deployed through an online gaming platform.

An exemplary online gaming platform is ridjit, which has modular plug-in capabilities and can deliver gaming capabilities described in the present invention to global partners, other gaming environments, and consumers. A description of ridjit may be found in co-pending U.S. patent application Ser. No. 13/117,917 filed on May 27, 2011, titled “Systems, Methods, Apparatus and Computer-Readable Mediums for On-Line Gaming”, the entire contents of which are hereby incorporated by reference.

The ridjit skill games solution offers a white label games platform allowing various brands to offer skill games for cash or for free, and, depending on regulatory jurisdictions, as a stand-alone site, or as part of a network of sites pooling the same player liquidity. Such sites may offer social networking features such as player profiles and messaging. The sites may specialise in Player vs. Player challenge features, allowing players to play against other online players in single matches (Match play), or as part of a variety of tournament types. The gaming platform may interface with such sites. Additionally, the platform may run random-number-generator (RNG) games in Europe. The ridjit platform also provides 2^{nd} chance solutions for lottery partners, as well as running loyalty programs and skill gaming.

An exemplary implementation and interface for ridjit can be found at http://www.internationalskillnetwork.com.

Some exemplary embodiments of the present invention are described below in the context of the ridjit gaming platform. However, the principles of the current invention apply equally to other platforms, gaming environments, lottery establishments, and venues in/on which a 2^{nd} chance draw may be exercised.

Also, some exemplary embodiments of the present invention are described below in the context of lottery-related 2^{nd} chance draws. However, the principles of the current invention apply equally to other types of gaming activities besides lotteries.

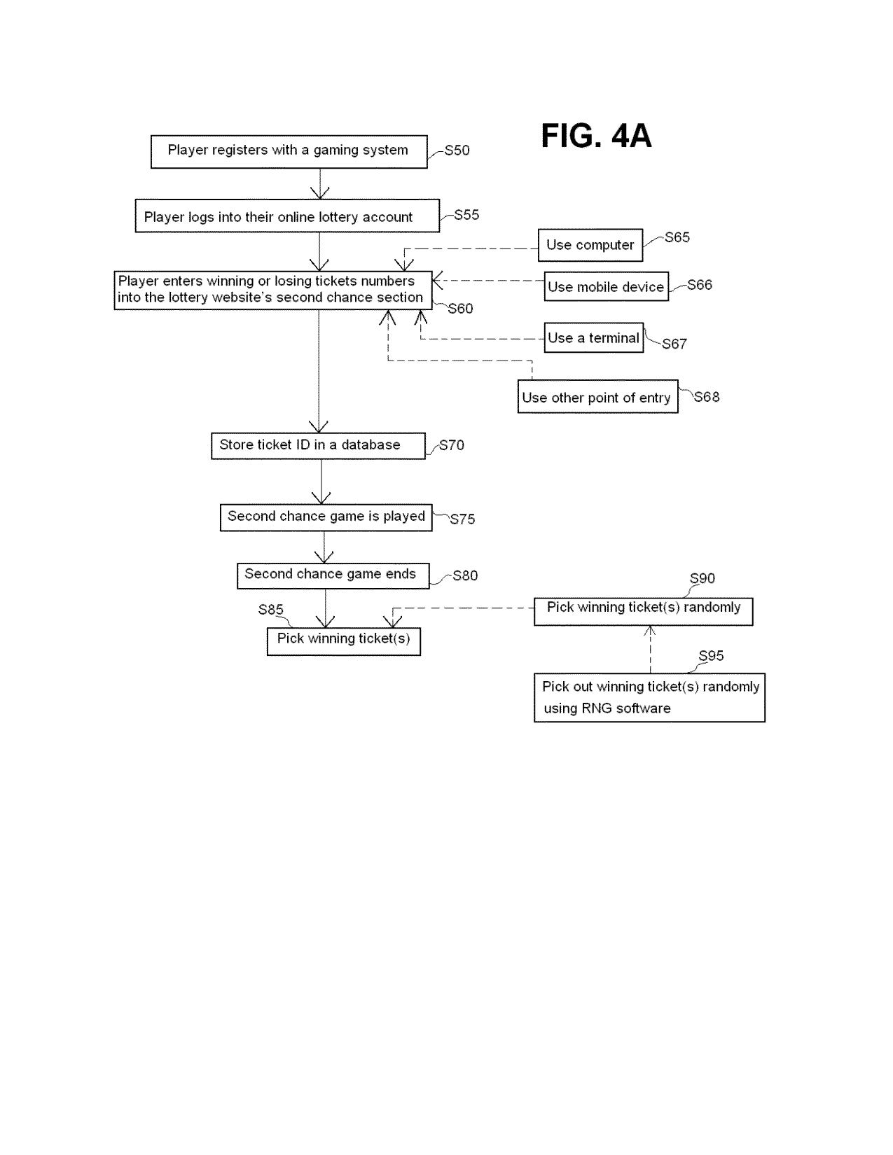

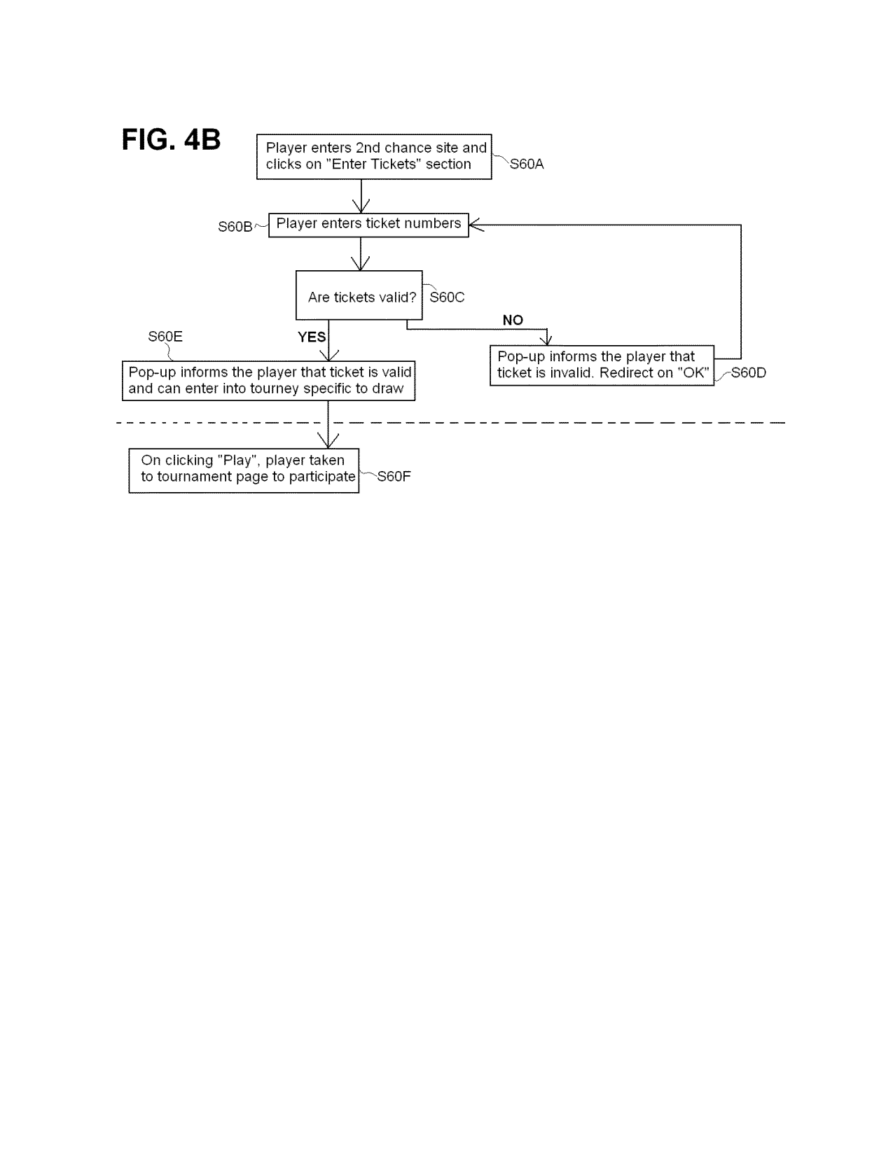

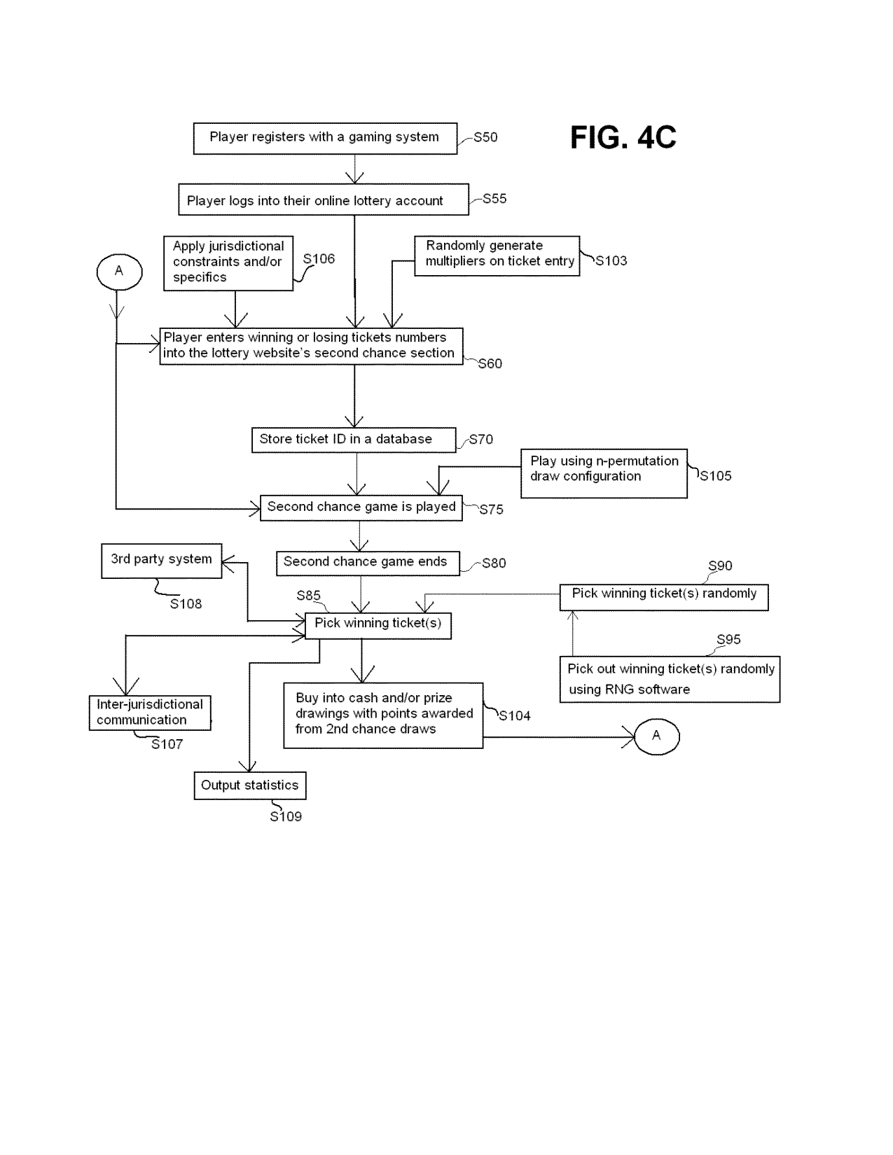

FIG. 4A is a general flow diagram illustrating a process flow for a 2^{nd} chance draw flow according to an embodiment of the present invention. As shown in FIG. 4A, a player may first register with a gaming system or other lottery or social site, etc., if the player has not registered before (S50). The player then logs into their online lottery account (S55), and enters winning or losing tickets numbers into the lottery website's 2^{nd} chance section (S60). That is, not only losing lottery tickets, but also winning lottery tickets, or unused lottery tickets (e.g., tickets which, for some reason, did not participate in the original lottery) may be used to enter a 2^{nd} chance game. For a lottery ticket winner, a 2^{nd} chance game may provide the possibility for even more winnings. This may be especially attractive for lottery winners who had won only a nominal amount in the original lottery.

The player may enter the ticket numbers via computer (S65), mobile device (S66), terminal (S67) or other point of entry (S68). The ticket ID is stored in a database (S70), and, when the 2^{nd} chance game is played (S75) and comes to an end (S80), winning ticket(s) are picked out (S85). Winning ticket(s) may be randomly picked out (S90), using certified RNG software (S95).

FIG. 4B is a flow diagram illustrating the beginning of a 2^{nd} chance draw according to an embodiment of the present invention. The 2^{nd} chance draw flow shown in FIG. 4B shows an exemplary implementation for how a 2^{nd} chance draw site may work on each page. In exemplary implementations, the first two pages of the flow, specifically steps S60A, S60B, S60C and S60D, may be the same as a standard site such as, for example, the CA lottery site (http://replay.calottery.com/).

The first section of the flow in FIG. 4B allows players to interact with the 2^{nd} chance site, where they can register if they have not yet done so, and can log-in and enter their tickets if they are pre-registered. After the player enters the 2^{nd} chance site and clicks on “Enter Tickets” section (S60A), the player enters ticket numbers (S60B). The site checks whether tickets are valid (S60C). If the ticket is not valid, a pop-up informs the player that the ticket is invalid and the player is redirected on “OK” (S60D). According to the present invention, if the ticket is valid, a pop-up informs the player that the ticket is valid and can enter into a tourney specific to draw (S60E). A tourney specific to a draw can either be a tournament that has been set up especially for the 2^{nd} chance draw promotion, or it can be any other defined tournament(s) for which the player is or has been issued one or more entries to be used on such tournament(s). On clicking “Play”, the player is taken to the tournament page to participate (S60F).

FIG. 4C is a general flow diagram illustrating additional details of a 2^{nd} chance draw according to an embodiment of the present invention. FIG. 4C provides additional details to the flow of FIG. 4A.

The 2^{nd} chance draw of the present invention may use randomly generated multipliers on ticket entry (S103), which may affect both the number of draw entries and loyalty points awarded to players. With the loyalty points awarded from 2^{nd} chance draws, players can buy into cash and prize drawings (S104). The 2^{nd} chance draw may also use an n-permutation draw configuration (S105). In an exemplary n-permutation draw configuration, if a player enters x tickets between t0 and t1 for game y, and a ticket for game b in the same timeframe, the player automatically gets a free entry/multiplied entry/etc.

In an exemplary embodiment, the 2^{nd} chance program of the present invention may be fully automated from end-to-end, including the RNG draw and claim process. The draw according to the present invention operates according to proprietary and pluggable draw and claim workflow engines, designed with operators in mind. The 2^{nd} chance draw allows submitting 2^{nd} chance entries via any web-enabled interface, including mobile phones and tablets. 2^{nd} chance tickets or credits/tokens may also be purchased in store to enter 2^{nd} chance draws, or play skill, sklot, or RNG games online, to win credits, points, or cash. Furthermore, skill or sklot gaming can award multipliers to 2^{nd} chance entry, which are used in, e.g., step S103 or S105 as shown in FIG. 4C. Sklot games are described in co-pending U.S. patent application Ser. No. 13/117,917, the entire contents of which are hereby incorporated by reference.

The 2^{nd} chance implementation of the present invention also provides a cross jurisdiction competitive advantage, because it allows operator and/or jurisdiction A to pool submissions with another jurisdiction B (S107). This can be implemented for certain games in exemplary embodiments, for example with the n-permutation process described above. The 2^{nd} chance draw may also be integrated with any 3^{rd} party player management system, loyalty engine, etc., per diagram, via secure API (S108). Furthermore, jurisdictional constraints or specific requirements can be applied to the 2^{nd} chance draw depending on the jurisdiction in which the draw is entered (S106).

The 2^{nd} chance draw program of the present invention may employ near-unlimited storage capabilities, may derive an event bus, and may derive real-time aggregated statistics (S109) output based on, e.g., results of various plays, player data and player participation, to be used in future 2^{nd} chance draws. The 2^{nd} chance program may scale to real-time operational capability for billions of submissions, and may integrate with any turnkey presentation software and/or media.

The 2^{nd} chance draw flow of the present invention may be implemented using systems and/or servers, or any computing device, and/or may run on commodity hardware. In an exemplary embodiment, a 2 GHz Opteron with 2 GB RAM is used to implement the 2^{nd} chance flow engine. The engine may incorporate pluggable database (DB) architecture, compatible with any DB system. In an exemplary embodiment, elements of the system engine may be written in Java, using open source products, such as, for example, Spring (www.springsource.org) and/or Hibernate (www.hibernate.org) to support it. However, any system platform, language, or product may be used and is not limited to the above.

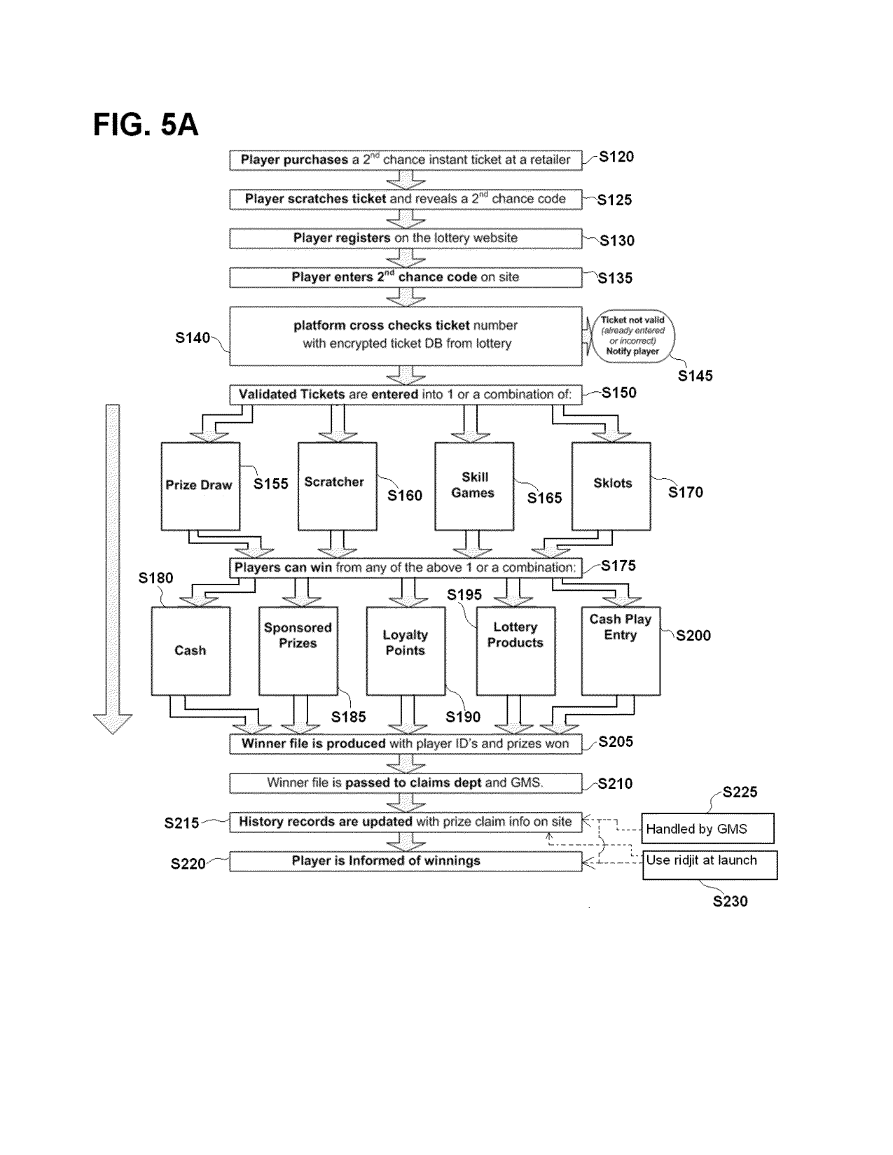

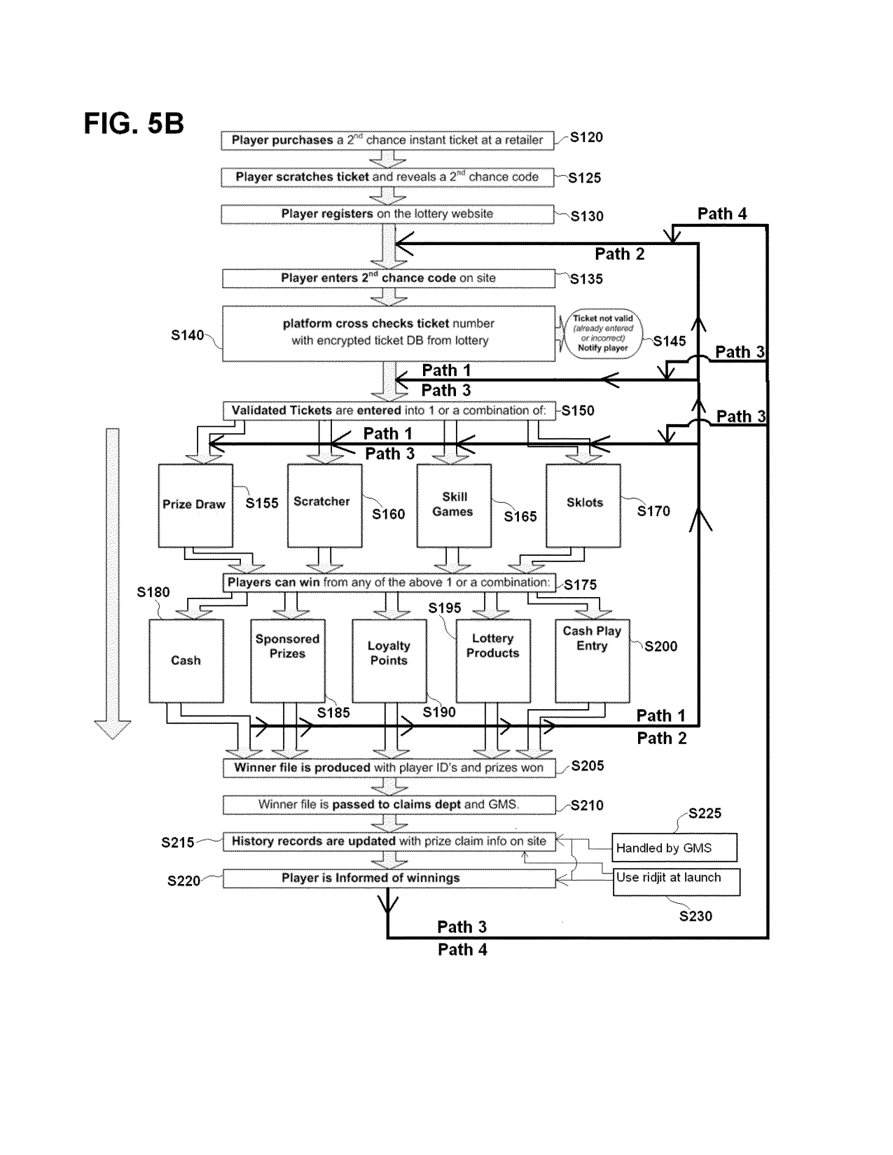

FIG. 5A is a flow diagram illustrating in more detail a process flow for a 2^{nd} chance draw flow according to an embodiment of the present invention. FIG. 5A illustrates an exemplary process flow for 2^{nd} chance scenarios in a 2^{nd} chance draw system. The system may be an interactive chance flow. In the illustrated process flow scenario, a player purchases a 2^{nd} chance instant ticket at a retailer (S120). For example, the player may buy the instant scratch ticket from their local retailer/outlet.

Players with non-winning tickets will be able to take their tickets and enter the 2^{nd} chance code from their ticket into a terminal such as, for example, their computer or a web enabled device, once they have registered or logged into the lottery site. Specifically, the player first scratches the ticket and reveals a 2^{nd} chance code (S125). The player registers on the lottery website if the player has not registered before (S130) and enters the 2^{nd} chance code on the site (S135). Exemplary codes that can be used as 2^{nd} chance codes are the serial number on an online ticket, the game pack VIRN on a standard instant ticket, or a 2^{nd} chance unique code (under a latex scratch area). Other types of ticket identifying information may also be used as a 2^{nd} chance code.

The platform (e.g., gaming platform, computing platform, social website or physical location, etc.) cross-checks the ticket number with an encrypted ticked database from lottery (S140). In an exemplary embodiment, the platform is the ridjit platform. If the ticket is not valid, for example because it has already been entered or is incorrect, the player is notified (S145).

Validated tickets are entered into one application, or a combination of applications (S150), such as prize draws (S155), scratchers (S160), skill games (S165) and sklots (S170). Other options for applications are also possible. For example, other options include slots, or additional products from the platform, which may include not only hybrid products skill-slots but also hybrid skill scratchers (sKratch), as well as any other games linked or created for the platform.

An exemplary prize draw is a standard 2^{nd} chance draw at a set time. Exemplary scratchers are online scratchers, 3×3 or complex scratchers, such as, for example, Arkadeville. Exemplary skill games are single play games or tournament games. Exemplary sklots are single play sklots or tournament sklots.

U.S. application Ser. No. 13/117,917, mentioned above, provides examples of scratchers such as Arkadeville, sKratch cards, skill, slot and hybrid games, and single play and tournament implementations.

Players can win from any of the above applications or from a combination, one or more rewards (S175). The wins can be in the form of cash (S180), sponsored prizes (S185), loyalty points (S190), lottery products (S195) and cash play entries (S200). Other types of wins are also possible. Exemplary sponsored prizes are merchandise, holiday items/packages, etc. Exemplary lottery products are barcode, coupons, etc. Cash play entries can be used, for example, in-venue (e.g., in a physical establishment) or online.

A winner file is produced with player-related information, such as, for example, player ID's and prizes won (S205), and the winner file is passed to claims department and GMS (S210). GMS is a games management system. For example, GMS may be a specific games management system that has been used for the CA lottery implementation. However, GMS may be any generic gaming management system.

History records are updated with prize claim info on the site (S215) and the player is informed of winnings (S220). The player may be informed of winnings by, e.g., email, SMS, in-account notification, snail mail, telephone call, or other type of notification. Various steps of the process flow, such as steps S215 and S220, may be handled by GMS (S225) and/or ridjit (S230).

The flow shown in FIG. 5A is a simplified version of a 2^{nd} chance draw process, and many variations may be implemented for the prize mechanics flow.

For example, the player can immediately use any of the winnings to play one or more of the games again (Path 1 in FIG. 5B), and/or can immediately use any of the winnings to enter the 2^{nd} chance gaming platform again (Path 2), and/or can use the winnings after notification to play one or more of the games again (Path 3), and/or to enter the 2^{nd} chance gaming platform again (Path 4).

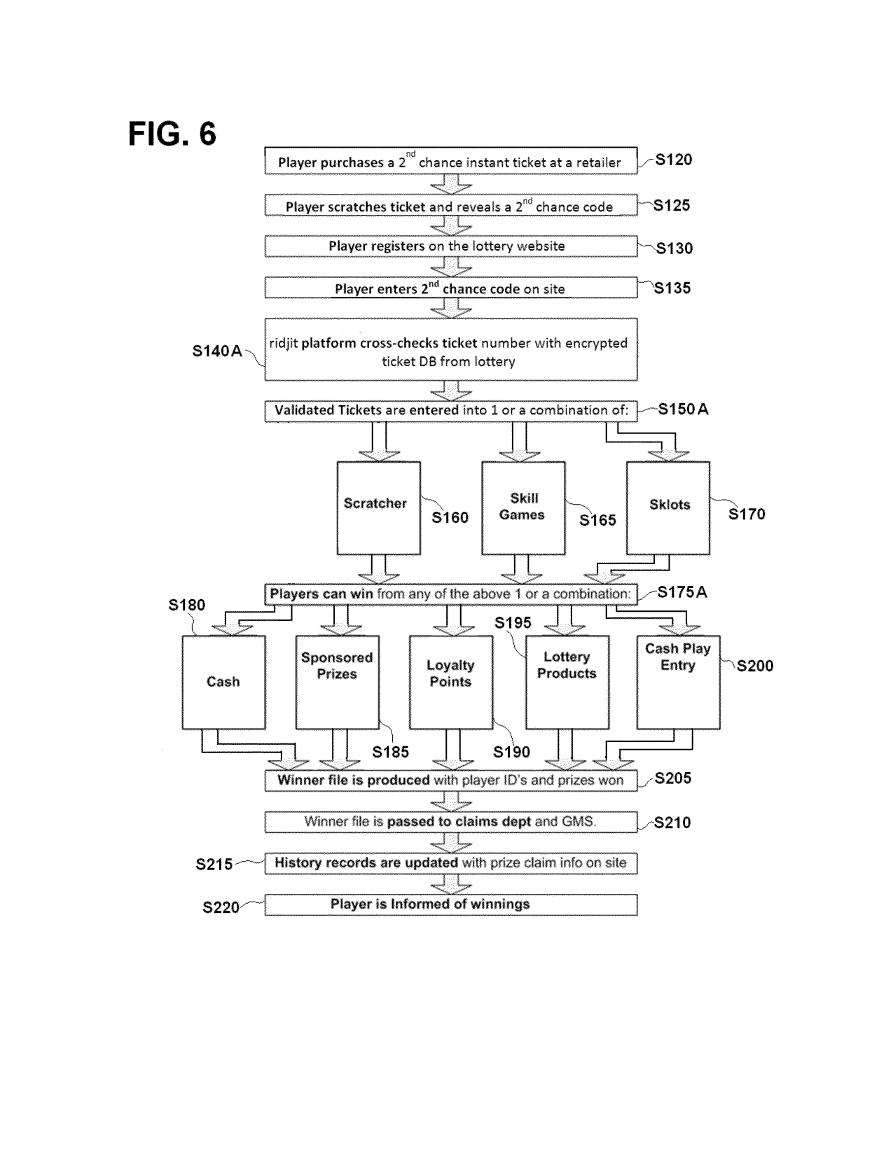

Once the player has entered the code (step S135), there are at least two options available on the platform/lottery side. In an exemplary case where the platform is ridjit, the first option, shown generally in FIG. 5A, is that ridjit cross-checks the ticket number with an encrypted ticket database from the lottery. This may require uploading files before a competition is run. Non-valid tickets will not be used and players will be notified. This may be a point of entry function (POE). An exemplary flow for this first option is shown in FIG. 6.

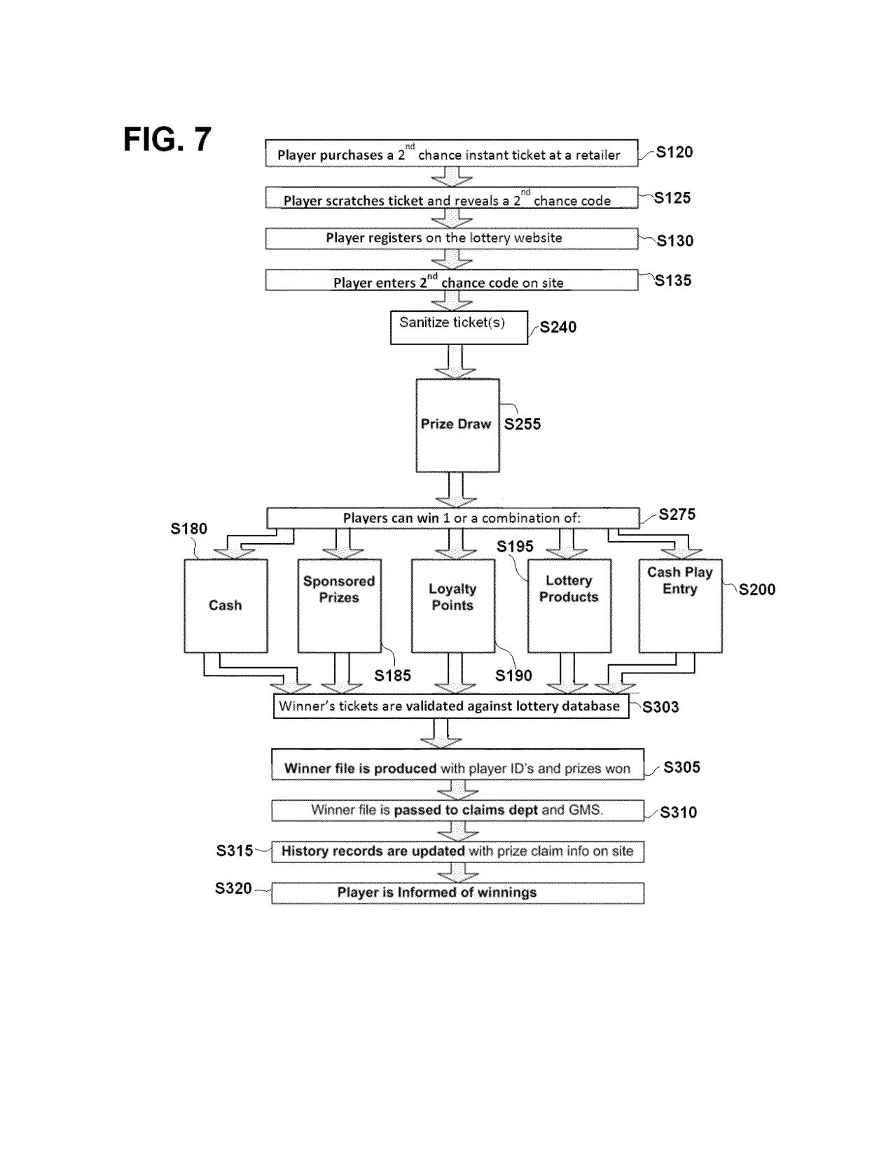

A second option after step S135 is to bypass the lottery's encrypted validation process and allow the ticket number to be recorded and processed on the ridjit platform. Processing via the ridjit platform will include checking that the right numbers of digits are used when the code is entered, and that the code has not been used before on the site for this draw. An example of a flow in accordance with this second option is shown in FIG. 7.

FIG. 6 is a flow diagram illustrating in more detail a process flow for a 2^{nd} chance draw in which a platform cross-checks a ticket number with an encrypted ticket database from a lottery, according to an embodiment of the present invention. As explained above, in this embodiment, after the player has entered the code (S135), an exemplary platform (ridjit in this embodiment) cross-checks the ticket number with the encrypted ticket database from the lottery.

In FIG. 6, after a player enters a 2^{nd} chance code on the site (S135), the ridjit platform cross-checks the ticket number with the encrypted ticket database from the lottery (S140A). Non-valid tickets will not be used and players may be notified. Validated tickets are entered into 1 or a combination of applications (S150A) such as a scratcher (S160), skill games (S165) and/or sklots (S170). Other options for applications are also possible. Exemplary scratchers are 3×3 or complex scratchers, such as Arkadeville. Exemplary skill games are single play games or tournament games. Exemplary sklots are single play sklots or tournament sklots.

Players can win from any of the above applications/combinations of applications, one or more rewards (S175A). The wins may be cash (S180), sponsored prizes (S185), loyalty points (S190), lottery products (S195), and cash play entries (S200). Exemplary sponsored prizes are merchandise, holiday items/packages, etc. Exemplary lottery products are barcodes and coupons. Cash play entries can be used, for example, in-venue or online.

A winner file is produced with player-related information, such as, for example, player ID's and prizes won (S205), and the winner file is passed to claims department and GMS (S210). History records are updated with prize claim info on the site (S215) and the player is informed of winnings (S220). The player may be informed of winnings by, e.g., email, SMS, in-account notification or other type of notification.

FIG. 7 is a flow diagram illustrating a process flow for a 2^{nd} chance draw in which a lottery's encrypted validation process is not used and the ticket number is allowed to be recorded and processed on the platform, according to an embodiment of the present invention. Specifically, in this 2^{nd} chance flow process, the lottery's encrypted validation process is not present, or is bypassed, such that the ticket number is allowed to be recorded and processed on the ridjit platform. Processing via the ridjit platform may include checking that the right numbers of digits are used when the code is entered, and/or that the code has not been used before on the site for this draw, and/or that the ticket is not too old, etc., thus “sanitizing” the tickets.

In the illustrated process flow of FIG. 7, a player purchases a 2^{nd} chance instant ticket at a retailer (S120). The player scratches the ticket and reveals a 2^{nd} chance code (S125). The player registers on the lottery website (S130), and enters the 2^{nd} chance code on site (S135). Tickets are then checked to determine whether they are unused, whether they have the right format, etc., thus sanitizing the tickets (S240), and sanitized tickets are entered into a prize draw (S255). An exemplary prize draw may be a standard 2^{nd} chance at a set time. Other options for applications are also possible.

Players can win one or more rewards (S275). The wins can be in the form of cash (S180), sponsored prizes (S185), loyalty points (S190), lottery products (S195) and cash play entries (S200). Other types of wins are also possible. Exemplary sponsored prizes are merchandise, holiday items/packages, etc. Exemplary lottery products are barcodes, coupons, etc. Cash play entries can be used, for example, in-venue or online.

Winner's tickets are then validated against the lottery database (S303), and a winner file is produced with player-related information, such as, for example, player ID's and prizes won (S305). The winner file is passed to claims department and GMS (S310), and history records are updated with prize claim info on site (S315). The player is also informed of winnings (S320). The player may be informed of winnings by, e.g., email, SMS, in-account notification or otter type of notification.

As shown in FIGS. 5, 6 and 7, after the player has entered their 2^{nd} chance ticket number, he will be entered into one or more of the following options: Prize Draw, online Scratcher, Skill Game or Slot, or other products on the platform, including hybrid products skill-slots (sklots) and skill scratchers (sKratch), as well as any other games linked to or created for the platform.

A Prize Draw is a standard event where each ticket number is counted as an entry to a tournament. Once the draw is closed, a set amount of winners are picked. The Scratcher may be a standard online 3×3 scratch-card, or a more complex scratch card with a skill game product (sKratch) available on the platform.

The Skill Games option allows players to play a skill game from the ridjit platform in either single play mode or tournament mode. In single player mode, the players with the top scores at the end of competition will be awarded prizes. In tournament mode, the top finishing players will be awarded prizes.

The sklots combination allows players to have one free session on a designated Sklot machine (e.g., a proprietary skill slot game) or participate in a Sklot tournament.

In an exemplary tournament, players may be provided with a set number of credits, and they have x spins to earn prizes in standalone mode. In tournament mode, all players will be given the same amount of chips. The players with the most amounts of chips at the end of the set time period will appear on a payout table, and will receive prizes according to a predetermined prize structure. The ridjit platform also supports the addition of 3^{rd} party game content.

As shown in FIGS. 5, 6, and 7, various prizes may be awarded in a 2^{nd} chance draw. Prizes available to players may include Cash, Bonus funds for game play, VLT credits, Sponsored Prizes, Loyalty Points, Lottery Products, and Cash Entry Play. The ridjit platform allows inventory management and direct linkage to 3^{rd} party consumer web stores.

For a cash prize, to ensure that players' entries are valid, e.g., that the players are allowed to play, the ridjit platform uses an age verification process, using 3^{rd} party software, for example. An exemplary integrity software is described at http://www.aristotle.com. This would ensure that the users are over 18 or the legal age of the respective jurisdiction, to play lottery products. When creating an account, players who do not successfully pass the automated process will be required to validate their age by sending in documentation.

When players have won prizes and need to claim them, they will be required to provide proof of identity, and fill tax or prize receipt forms. Both can be sent to the claims team or can be uploaded to the website.

Should a player receive a cash prize, the winner's file is passed to the claims department and ridjit. Once a manual check has been done by support staff to ensure that the player is eligible to be accepted, e.g., to ensure that the player has entered legible information, that he doesn't work for the lottery or any of the site, software or marketing companies delivering the product, etc., ridjit will update the history records with prize claim info on the site and the player will be informed of his/her winnings via email, SMS or other specified notification method. Players may also be notified at login on the site. Players would have to confirm that they have viewed their winning notification before they can continue to navigate the site.

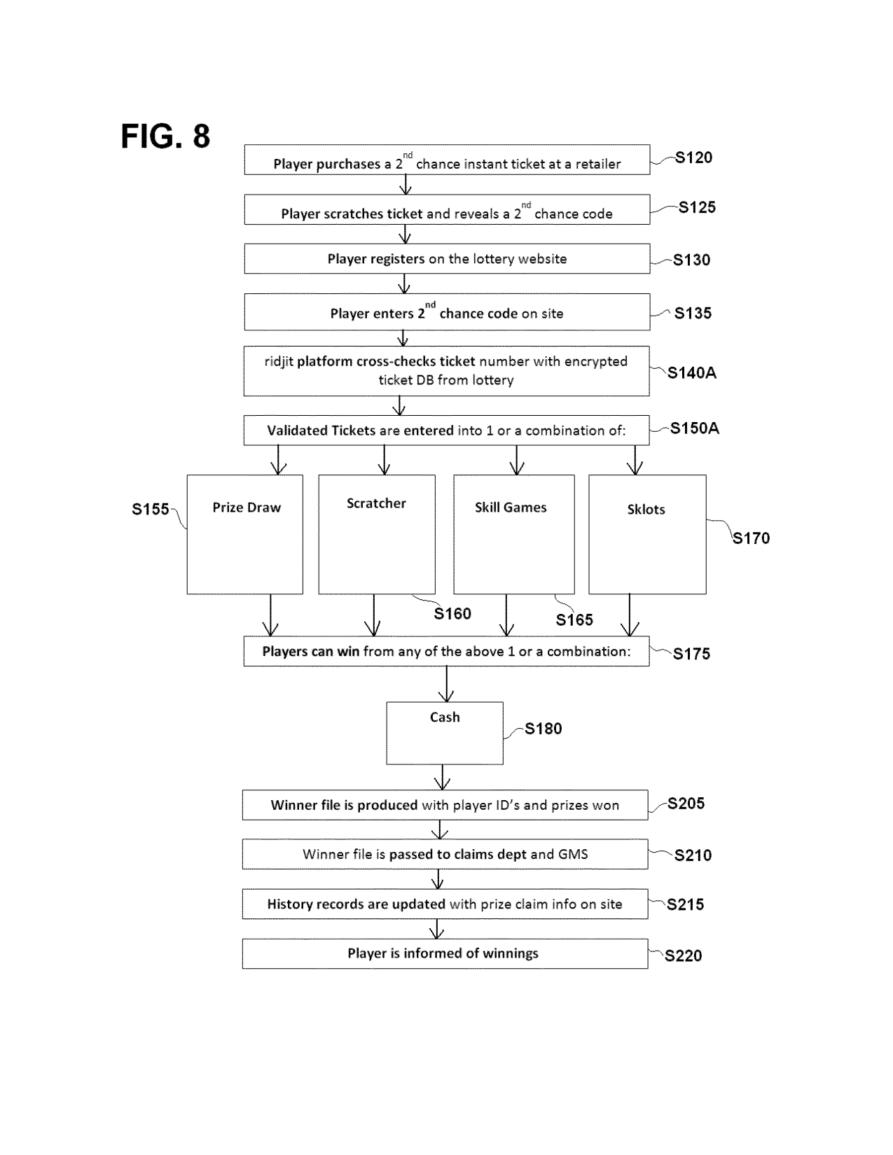

FIG. 8 is a flow diagram illustrating an exemplary 2^{nd} chance draw process flow in which players win cash, according to an embodiment of the present invention. The steps in the flow in FIG. 8 proceed in a similar fashion to same-numbered steps in FIGS. 5A and 5B.

In the flow of FIG. 8, a player in a 2^{nd} chance draw can enter a prize draw (e.g., a standard 2^{nd} chance at a set time), a scratcher (e.g., a 3×3 or complex scratcher, such as, for example, Arkadeville), skill games which may be single play or tournament, sklots which may be single play or tournament, or other types of draws, and can win cash from any combination of these draws and games.

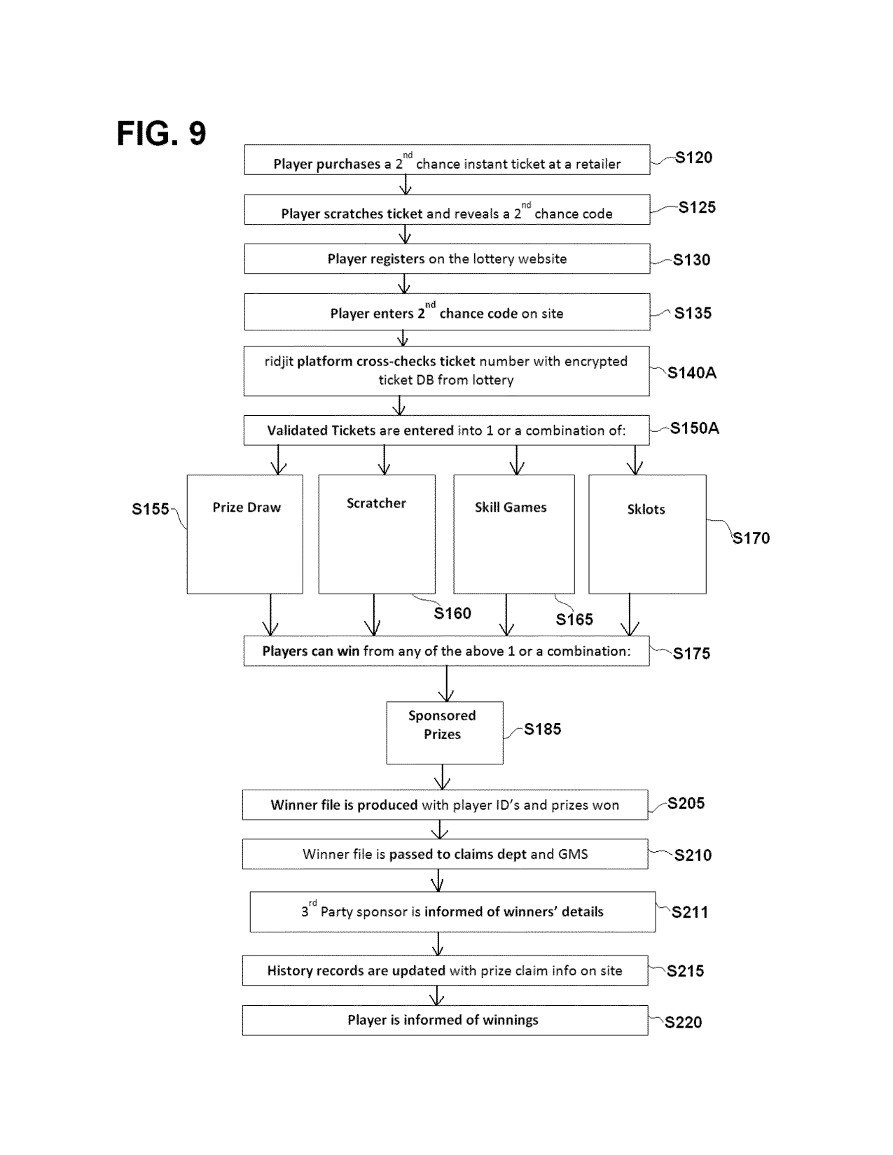

FIG. 9 is a flow diagram illustrating an exemplary 2^{nd} chance draw process flow in which players win sponsored prizes, according to an embodiment of the present invention. The steps in the flow in FIG. 9 proceed in a similar fashion to same-numbered steps in FIGS. 5A and 5B.

In the flow of FIG. 9, a player in a 2^{nd} chance draw can enter a prize draw (e.g., a standard 2^{nd} chance at a set time), a scratcher (e.g., a 3×3 or complex scratcher), skill games which may be single play or tournament, sklots which may be single play or tournament, or other types of draws, and can win sponsored prizes (e.g., merchandise, holiday packages, etc.) from any combination of these draws and games (S185). A sponsored prize may be a prize implemented by a 3^{rd} party.

Should a player win a sponsored prize, the claims department would verify the win, then the winner's biographical details will be passed onto the 3^{rd} party sponsor who is providing the prizes, so that they can be sent out accordingly. Thus, after the win, the 3^{rd} party sponsor is informed of the winner's details (S211) before the winner receives the prizes won. The lottery website is updated with the prize claim information and the player will be informed via email, SMS or similar notification that they have won a prize (S220). Alternatively, the 3^{rd} party can give the lottery coupons, which can be offered to players on the website to print out, or to be scanned at a retailer via a mobile device.

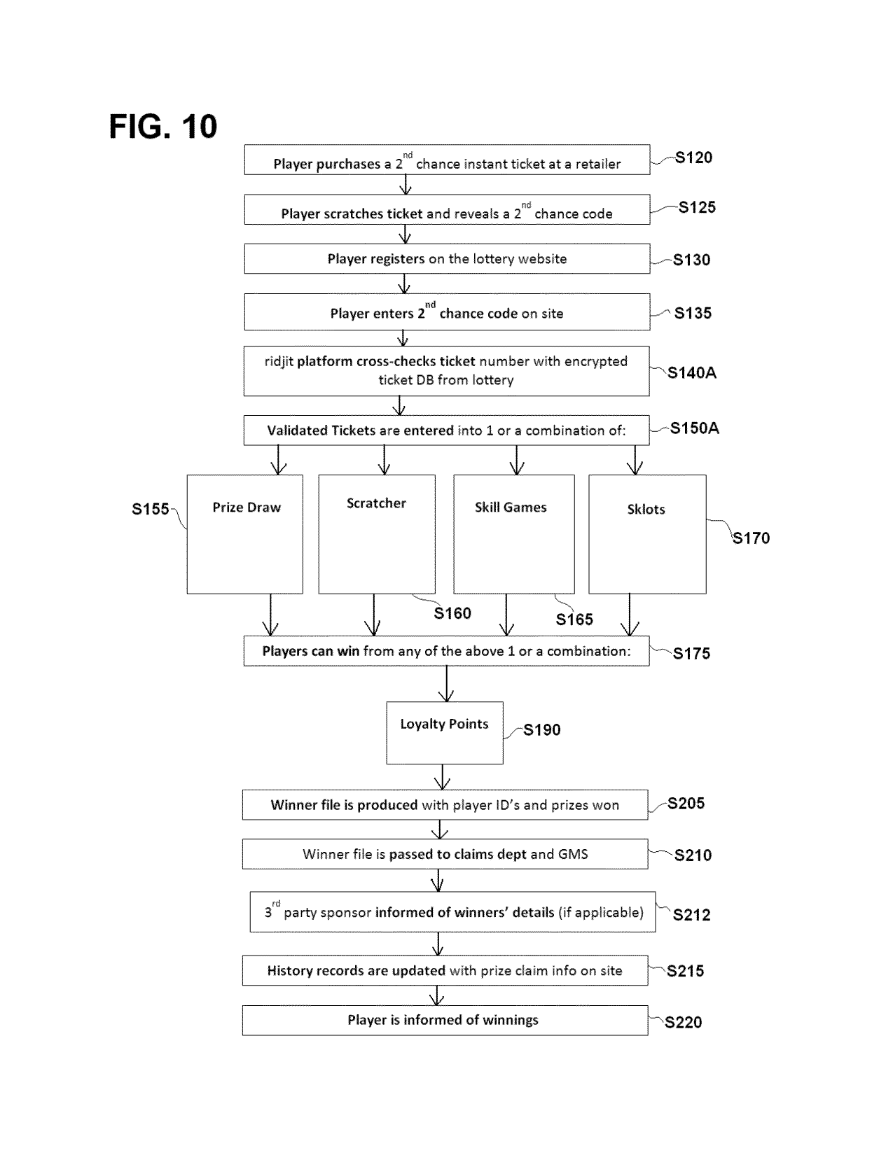

FIG. 10 is a flow diagram illustrating an exemplary 2^{nd} chance draw process flow in which players win loyalty points, according to an embodiment of the present invention. The steps in the flow in FIG. 10 proceed in a similar fashion to same-numbered steps in FIGS. 5A and 5B.

In the flow of FIG. 10, a player in a 2^{nd} chance draw can enter a prize draw (e.g., a standard 2^{nd} chance at a set time), a scratcher (e.g., a 3×3 or complex scratcher), skill games which may be single play or tournament, sklots which may be single play or tournament, or other types of draws, and can win loyalty point prizes (S190) from any combination of these draws and games. Once the player is confirmed as a winner, the files can be passed to the claims department and ridjit, so that the loyalty points can be added to the player's account. The details are updated on the lottery site, and the player will be informed via email, SMS or similar notification that they have won a prize (S220). Loyalty points can be automatically added to the player's account. Loyalty points can be provided by various entities or sites, such as a loyalty points system or through integration to a 3^{rd} party loyalty provider.

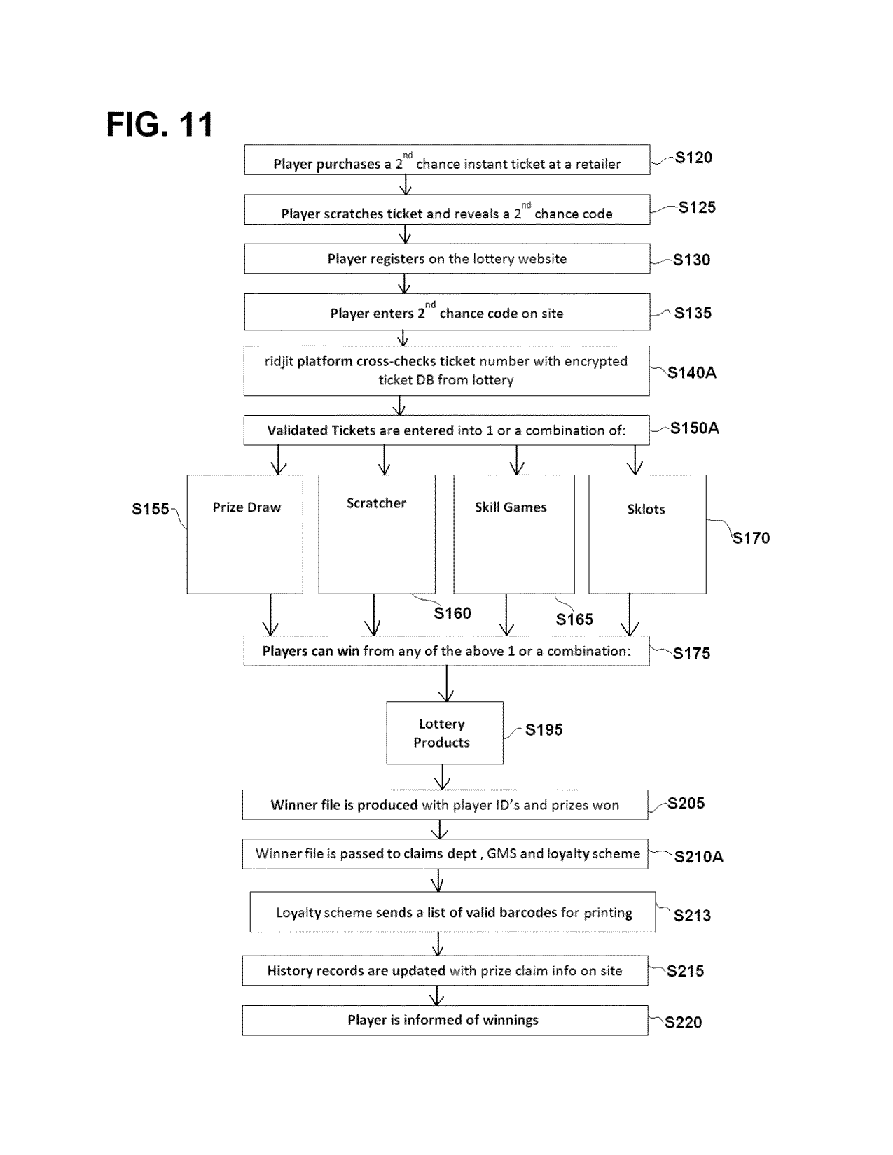

FIG. 11 is a flow diagram illustrating an exemplary 2^{nd} chance draw process flow in which players win lottery products, according to an embodiment of the present invention. The steps in the flow in FIG. 11 proceed in a similar fashion to same-numbered steps in FIGS. 5A and 5B.

In the flow of FIG. 11, a player in a 2^{nd} chance draw can enter a prize draw (e.g., a standard 2^{nd} chance at a set time), a scratcher (e.g., a 3×3 or complex scratcher), skill games which may be single play or tournament, sklots which may be single play or tournament, or other types of draws, and can win lottery products (S195) from any combination of these draws and games. The winner file is subsequently passed to claims department, GMS and the loyalty scheme (S210A). The claims department will verify that the player is valid. The loyalty scheme sends a list of valid barcodes for printing (S213). The lottery site may also be updated to inform players that of the prizes that are won, and the player is informed via email, SMS or similar notification that they have won a prize (S220). Players may follow an online claim process, may be presented with a barcode for products or promotions, or may be sent items by mail through the claims department. Players can print the coupon or present it on a web enabled mobile to be scanned at retail.

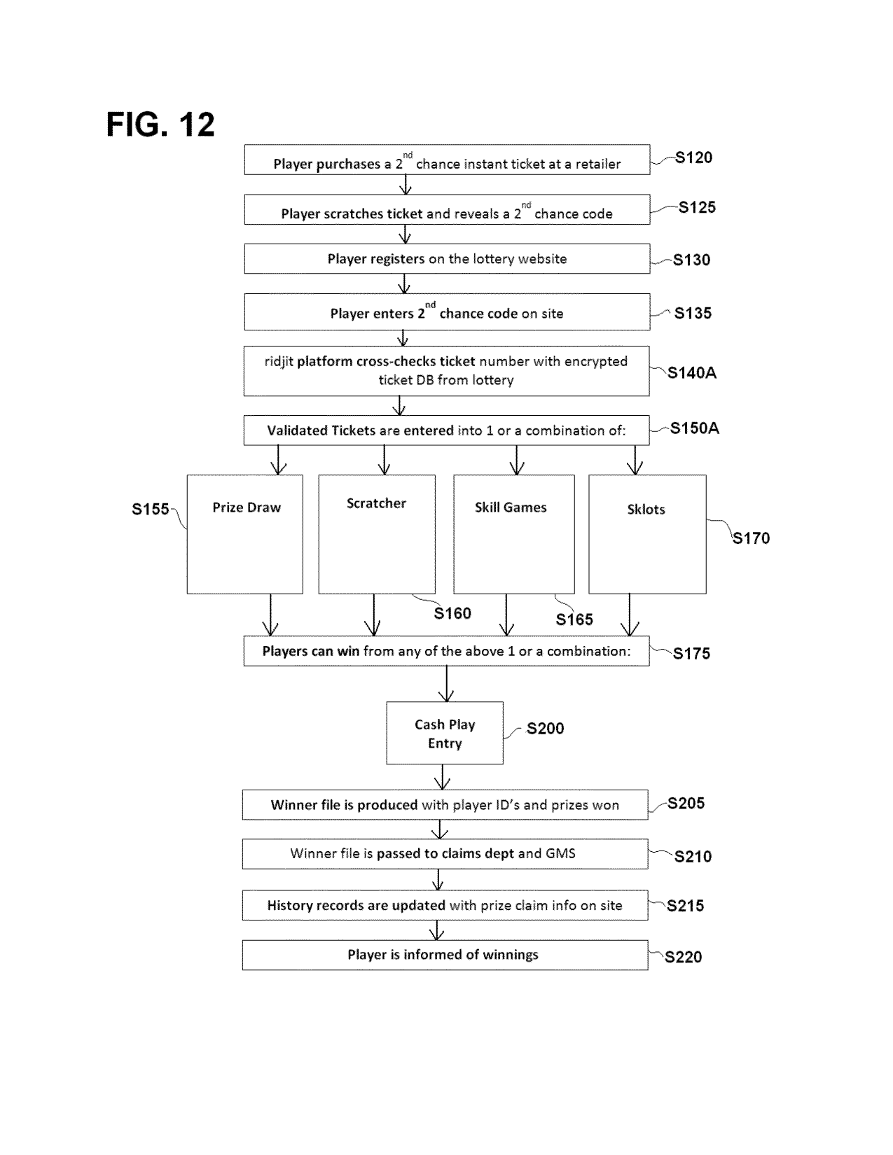

FIG. 12 is a flow diagram illustrating an exemplary 2^{nd} chance draw process flow in which players win cash play entries, according to an embodiment of the present invention. In the flow of FIG. 12, a player in a 2^{nd} chance draw can enter a prize draw (e.g., a standard 2^{nd} chance at a set time), a scratcher (e.g., a 3×3 or complex scratcher), skill games which may be single play or tournament, sklots which may be single play or tournament, or other types of draws, and can win cash play entries from any combination of these draws and games (S200).

In-venue or online cash entry prizes are prizes such as prizes paid for gaming on the ridjit platform or within a gaming venue, such as a casino or applicable outlet. Tickets may be checked at POE for this payment method to work efficiently. The claims department and ridjit will verify that this player is a winner, and notification will be sent to the player via email, SMS or similar. The player can be sent a coupon that can be scanned in store, or credit may be added to an online account that can be accessed at a licensed venue, on a web enabled terminal, or using a loyalty claim card.

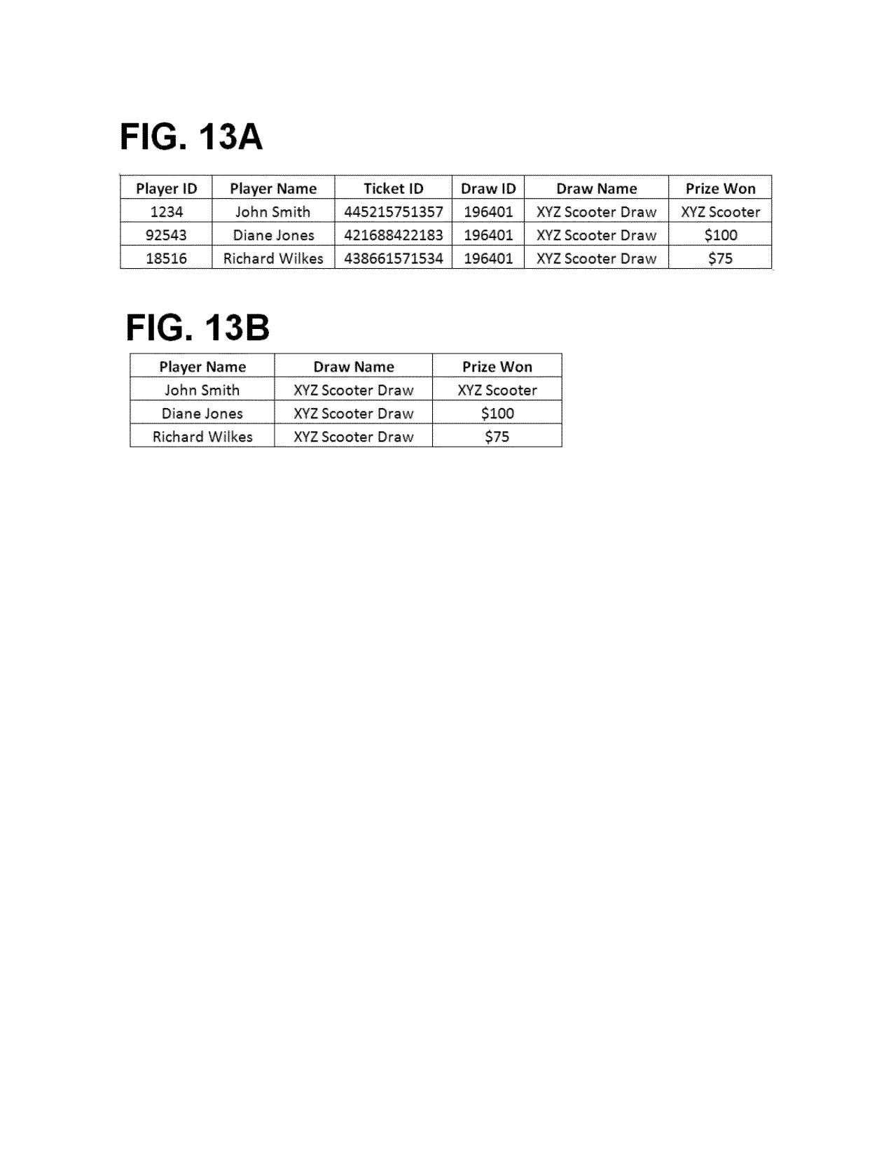

FIG. 13A illustrates an exemplary back office report produced for history records, and FIG. 13B illustrates an exemplary history version which may be used for the main lottery sites, on which the platform may show a simplified version of the history shown in FIG. 13A. Following the draw and the validation (if required), this information may be manually inputted into the back-end to update the site.

### Random Multiplier

To add entertainment value and increase excitement for a game to the 2^{nd} chance draw entry mechanics, a unique format may be used where player's entries are multiplied by a number using a Random Number Generator (RNG) and a predetermined paytable which affects the benefits received by the entry.

A multiplier may be included in the paytable implementation. The multiplier uses a specific paytable allowing the 2^{nd} chance draw provider/site to set a budget and define on average the extra benefits players will receive from the multiplier. The multiplier can relate to entries to draws, loyalty points awarded, game tournament entries, VLT credits or any other benefits within the system that need to be linked, depending on the outcome.

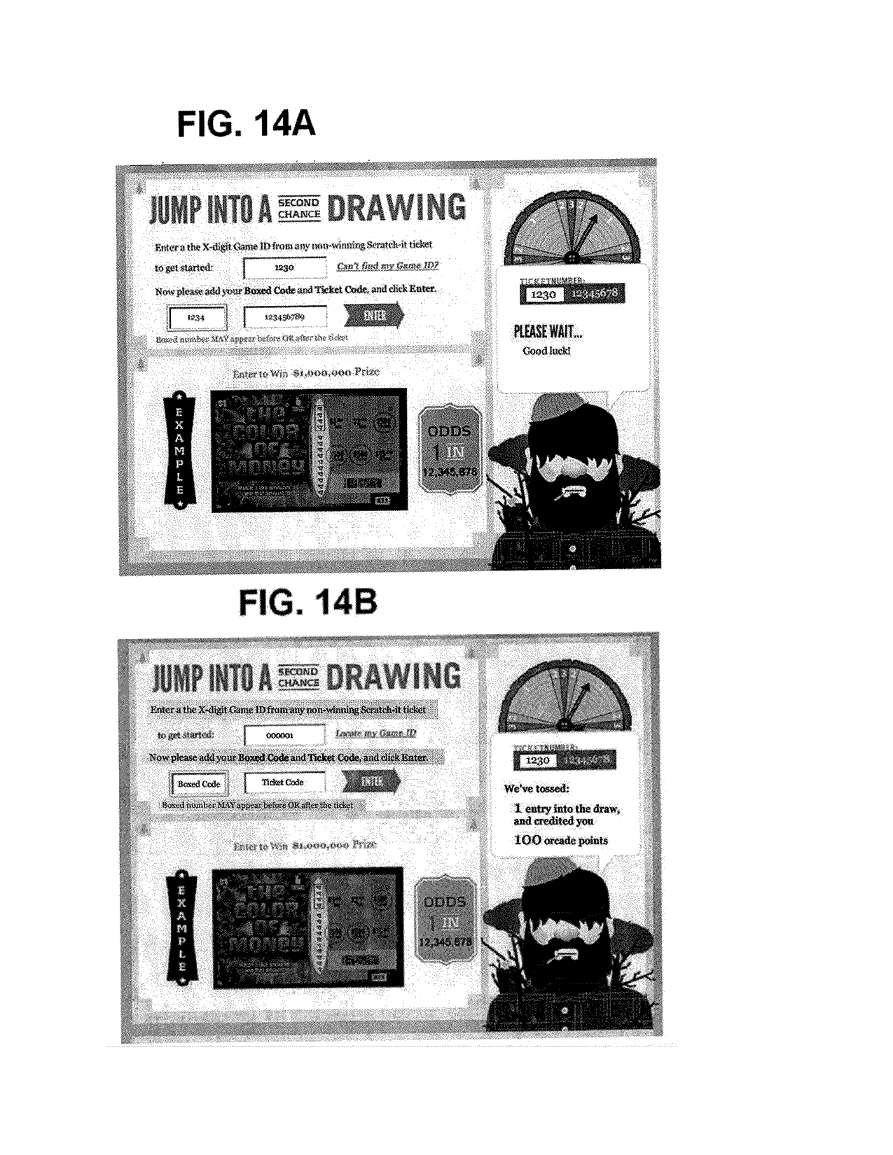

In an exemplary implementation, players submit their ticket code into the website/mobile interface or mobile app. Clicking enter starts the RNG process to determine the player's multiplier, as shown in FIG. 14A. Once the multiplier is revealed, the benefits and the multiplication are revealed to the player, as shown in FIG. 14B. The exemplary screen shot in FIG. 14B shows the multiplier stopping on the number 1. Based on the screen shot in FIG. 14B, the RNG has determined that the player has earned one entry and also 100 loyalty points. Here, 1 entry to the draw is given to the player 1×(base points−100×$ value of the ticket, in this case, a $1 ticket)×1=100 loyalty points, while the base amount of points a player receives may or may not directly correlate with the value of the 2^{nd} chance ticket entered. In another embodiment, the award equation may have the form “Multiplier×(Base Points×ticket value)”. In yet another embodiment, benefits and multiplication may be decided using other algorithms. For example, one embodiment may manually determine different base values that may be unaffected by the ticket value.

### Random Multiplier Paytable

An exemplary paytable to receive a 150% payout, as in use with the Oregon lottery, enables awarding on average 1.5 entries into the 2^{nd} chance draw, and 1.5 times the loyalty points awarded for entering a 2^{nd} chance ticket.

An algorithm for selecting a random draw entry multiplier is implemented such that, on average, it generates exactly a preset number of entries per submission. In an exemplary implementation, the algorithm for selecting random draw entry multiplier is implemented such that, on average, it generates exactly 1.5 draw entries per submission. In this exemplary algorithm, RNG returns a number between 1 and 360. Number 360 is chosen because it's possible to divide it in such a way that would yield exactly 1.5 entries on average. Then the multiplier is chosen according to following table:

MULTIPLIER RNG VALUE RNG
REGION SIZE MULTIPLIER × RNG
SIZE PROBABILITY (RNG/360)
1 1 . . . 240 240 240 66.66%
2 241 . . . 320 80 160 22.22%
3 321 . . . 344 24 72 6.66%
4 345 . . . 356 12 48 3.33%
5 357 . . . 360 4 20 1.1%
Total 360 540

Total number of MULTIPLIER×RNG=540, which divided by 360, yields exactly 1.5. The base loyalty points determined per dollar entry per ticket took into account the 1.5 multiplier paytable during the creation, to achieve the required dollar value on ticket entries. Other dollar values on ticket entries may also be implemented, using other number of entries per submission.

Multipliers may also be used to determine the amount of entries that a player earns by entering a 2^{nd} chance ticket. Once again, the multiplier on the amount of entries earned may be a soft RNG, which means that when a player enters one ticket into the draw, they could potentially earn more than one entry for that ticket. The paytable for the multipliers is set according to customer specifications, allowing customers to know on average how the multiplier will affect the mechanics and economy of ticket entries and loyalty points awarded.

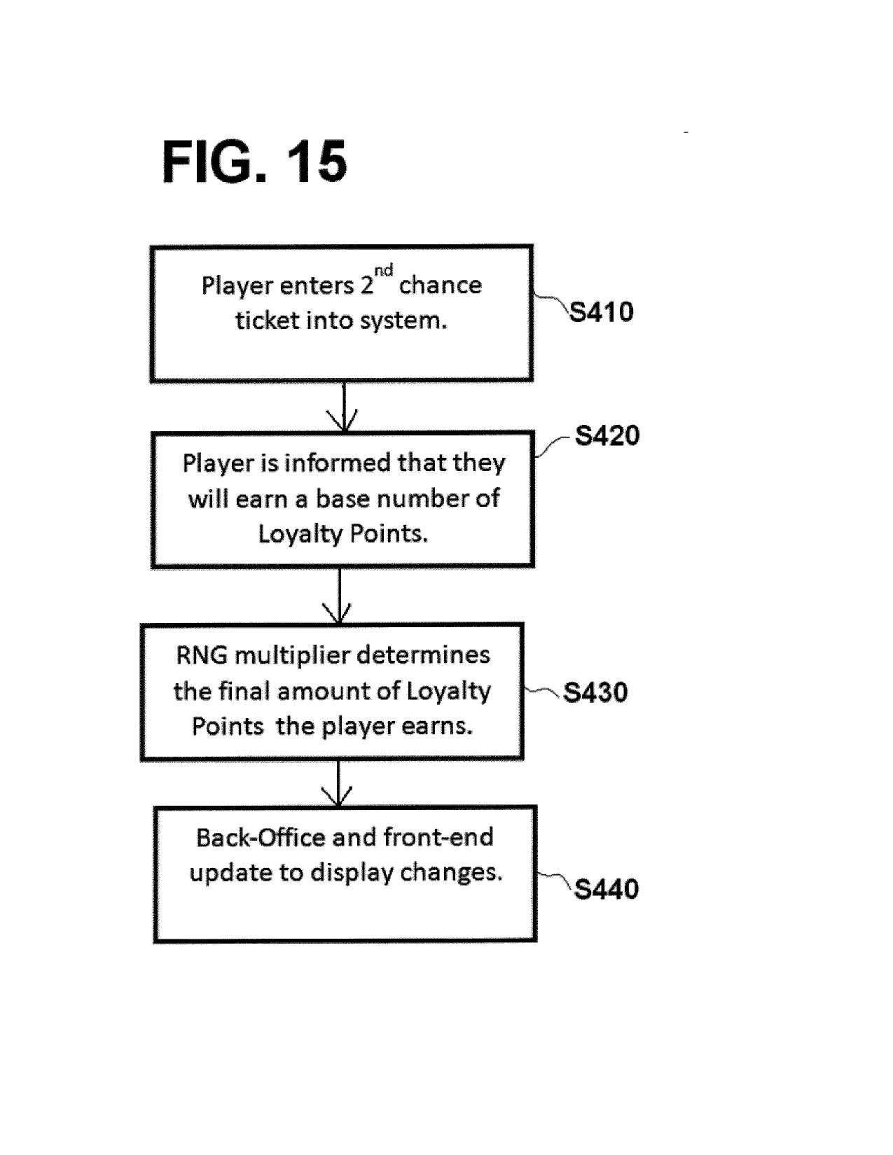

This 2^{nd} chance implementation can be used to encourage players to use the 2^{nd} chance program more regularly, as the rewards are greater. A flow of the process using an RNG multiplier is shown in FIG. 15. In the flow in FIG. 15, a player enters a 2^{nd} chance ticket into system (S410). The player is then informed that he will earn a base number of Loyalty Points (S420). An RNG multiplier determines the final amount of Loyalty Points the player earns (S430). The back-office and front-end also update to display changes (S440).

Multiplier used as a Random Prize Selector

In an exemplary implementation, the multiplier can be used as a random prize selector. The site that administers the 2^{nd} chance draw may be configured to manage and monitor physical and cash prizes using the multiplier. In this case, the multiplier can be used to determine a spot prize offered to a customer, instead of or in addition to multiplying a base amount of draw entries, loyalty points or the like.

For example, if the lottery has an inventory of gifts and prizes, the RNG can choose at random the prize to be offered after the entry of tickets. A paytable may be created for this purpose, taking into account the availability of certain prizes. For example, if the lottery has thousands of hats to award, these may appear more frequently, while large prize wins may appear more rarely.

### Interchangeable Paytables

Paytables and paytable types may also be implemented to be interchangeable and selectable. For this purpose, tickets entered into the system may also include their cash value (e.g., cost), which allows the gaming platform to determine, by ticket or value, which paytable to offer to the players. This may allow the players to receive different prizes using the random prize selector, or to receive loyalty points based on a certain selected paytable, etc. That is, types of paytables (e.g., paytable associated with cash, sponsored prizes, loyalty points, lottery products or cash play entries) and values determining the paytables may be selected when a ticket is entered for a 2^{nd} chance draw, depending on the value of that ticket.

### Transparent Odds

In an exemplary embodiment, real-time odds are displayed to the user before entering each ticket. The odds may be updated, for example to the nearest X minutes, depending on configuration and optimization per site. In an exemplary embodiment, the odds are updated substantially every 2 minutes.

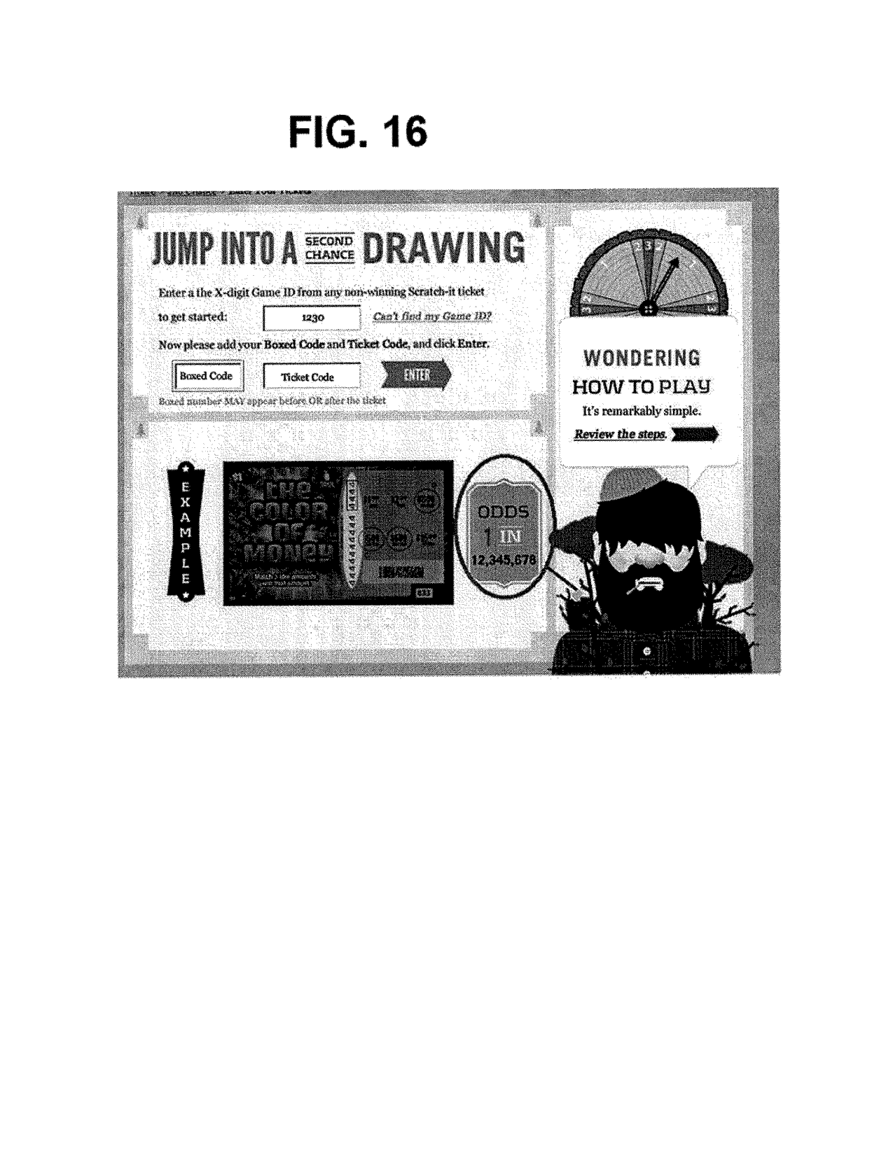

Users can also compare the odds on different draws, which helps them make educated choices about their chances of winning, before purchasing their next scratchers. FIG. 16 illustrates an exemplary screen shot in which a user can review the odds for a 2^{nd} chance draw before playing the draw.

Buying into a Drawings with Loyalty Points

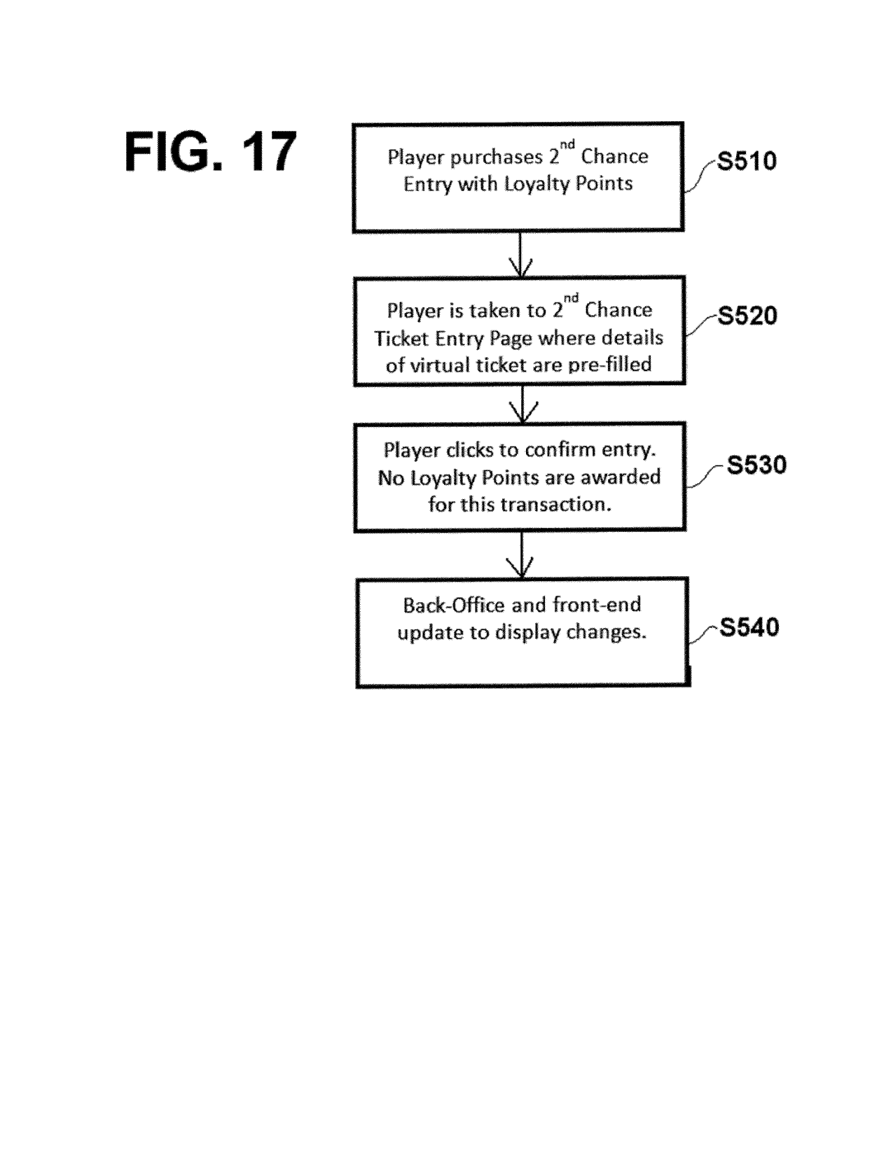

In an exemplary embodiment, players can use the Loyalty Points they have earned by, e.g., entering tickets into the 2^{nd} chance draws or accessing the ridjit platform or by other specified method, to purchase entry into designated 2^{nd} chance draws, where regulation permits. A flow of the process is illustrated in FIG. 17.

As shown in FIG. 17, a player purchases a 2^{nd} chance entry with Loyalty Points (S510). Once a player clicks to purchase, the player is taken to the 2^{nd} chance ticket entry page where the virtual ticket details are pre-generated in all the fields (S520). The player then just needs to click to confirm and all details will be inputted and updated. It is noted that in this embodiment, all entries that are purchased with Loyalty Points will be classed as virtual tickets, which means that they function in the same way as a second chance ticket entry, except that players don't get Loyalty Points for entering them. Thus, virtual tickets act in the system in the same way regular tickets, but the virtual tickets have to be allocated to a user, as opposed to the user having their unique ID from a scratch ticket purchased at retail.

The player then clicks to confirm entry (S530). No Loyalty Points are awarded for this transaction. The back-office and the front-end update to display changes (S540).

### Surveys and Questionnaires

The 2^{nd} chance draw system allows flexible draw entry options so players could perform a number of actions to enter the draw, either in tandem with ticket entry, or instead of ticket entry. Actions deemed valuable to a lottery can be used as entry purchase into a draw.

In an exemplary embodiment, players may enter draws with loyalty points, and in addition, may be asked to fill in a survey to be allowed entry. Players may be asked to answer a questionnaire which requires a purchase or other interaction with lottery products.

Further, entry into a 2^{nd} draw can be triggered by players answering correct questions in a quiz about the lottery products. The answers may be answers that are only available to people purchasing or interacting with lottery products. An example of such question could be a question regarding the highest stake allowed on a specific VLT slot machine in a licensed venue. Players would have to go to a venue to get this information, which would also lead them to interact with the lottery products or some other item that the lottery deems valuable. A correct answer by a player to the question can then be rewarded with a 2^{nd} chance entry.

### Bonus Codes and Coupons

In an exemplary embodiment, entry to a 2^{nd} chance draw may also be achieved by entering a unique bonus code from scratch tickets of any other purchasable products from the lottery.

For example, the lottery may give out codes to players purchasing specific or multiple tickets, or create scratchers for which the only prize is one or more entries into 2^{nd} chance draws. Such codes/scratchers may be purchased at retail or offered as bonuses for other purchases or successful play on the website, or on a lottery video terminal (VLT) in licensed premises.

### Access to 2^{nd} Chance Draws

2^{nd} chance draws may be entered via any web-enabled interface, such as, for example, mobile phones and tablets. Players may access 2^{nd} chance and other ridjit site pages using devices such as mobile or portable devices, as well as their PC or laptop, using a lottery site that employs, for example HTML5, with which many mobile/portable devices are compatible. Players may also interact on all parts of the 2^{nd} chance draws that are available on the website, and also on a mobile web interface.

Native applications, implemented according to the present invention for iPhone, Android, RIM and other mobile operators and devices may be used to allow players to interact, on their mobile devices, with the above-mentioned applications. One of the advantages of a native app, as opposed to web enabled devices, is the ability to store detailed information on a mobile device while the device is offline, such as, for example, when out of network reach. A user may enter into the app the details of their tickets, and only apply the interaction with the 2^{nd} chance platform(s) when they go online.

### 2^{nd} Chance Ticket Entries for Tournaments

2^{nd} chance ticket entry may also enable players to enter skill tournaments or tournaments associated with other products. For example, players who purchase 2^{nd} chance tickets may enter into skill applications such as, for example, skill games, Poker, etc., and into sklot, slot, Bingo tournaments and games, where the winnings are determined according to the player's score or success in these games. Entering 2^{nd} chance tickets can reward players with virtual currency to play cash games, lottery games, RNG games, skill games and other games one on one. Entry into 2^{nd} chance draws may also give players coupons. These coupons are not the same as the loyalty points that give coupons, and can be used to purchase lottery products in retail, or even 3^{rd} party retail. For example, the coupons may be (or may be used to purchase) Amazon.com vouchers.

### Awarding Multipliers to 2^{nd} Chance Entries

In an exemplary embodiment, playing skill games may award multipliers to a 2^{nd} chance entry. Players can play skill games, either 1-on-1 or in tournaments, where their final score and success can affect the multiplication of 2^{nd} chance entries placed into a draw. For example, a player who wins a skill tournament could earn a 5× multiplier on the amount of entries they receive, after entering a ticket into the 2^{nd} chance draw.

### Purchase of 2^{nd} Chance Tickets or Credits/Tokens in Store

2^{nd} chance tickets or credits/tokens may be made available in store. In-store availability may be implemented using current technology, or may be implemented as needed, e.g., in connection with launch of an individual 2^{nd} chance gaming system in a certain geographical area or at a certain digital location. Thus, 2^{nd} chance tickets or credits/tokens could be purchased to enter 2^{nd} chance draws or play skill or RNG games online to win credits, points or cash. Players may then purchase scratch tickets from retailers, as well as virtual credits or tokens, which can be used to enter 2^{nd} chance draws or play skill or RNG games, which can payout credits/tokens, loyalty points or cash prizes.

Within this exemplary implementation, players are able to use the 2^{nd} chance tickets for more than one function. This means that the player can have the option to enter the ticket into a draw, or enter the ticket into events such as, for example, skill tournaments, providing them with an entry into the tournament. Alternatively, they may wish to enter their 2^{nd} chance ticket into playing an RNG style game such as, for example, a virtual scratch card or sklot/slot, in which the player can win virtual credits or tokens to be used elsewhere, loyalty points or even cash prizes, depending on the lottery partner's request.

Similarly, players may be able to purchase virtual token/credits at a retailer to apply to their account online, where they can perform the same functions, use the credits to purchase a 2^{nd} chance entry, enter skill events, or even play RNG games for the chance to earn further virtual currency, loyalty points or cash prizes.

### N-Permutation Draw Configuration

The 2^{nd} chance engine of the present invention may create an ad-hoc drawing or a repeating, scheduled drawing, based on any parameters that exist in the platform, based on the value of these parameters, or aggregate (computed) values of many parameters. Tickets entered into the draw system may be entered into multiple draws, planned in advance, or added ad-hoc depending on promotional needs.

In an exemplary implementation (1), all submissions where submission time t is 2011-01-01 00:00:00≦t<2011-03-01 00:00:00 are eligible for entry into drawing. In a more complex example (2), all submissions where it's a Monday, Wednesday or Friday, where submission time is t: 2011-01-01 00:00:00≦t<2011-03-01 00:00:00, for game XYZ are eligible for entry into drawing. In an even more complex example, all submissions where the player has at least three submissions in the (1) drawing, and five in the (2) drawing, made on any date between 09:00:00≦t<11:00:00, are eligible for entry into drawing.

### Full Automation End to End

In an exemplary embodiment, the whole back-end process may be fully run without human interaction after the system is initially set up. Manual checks by external partners may still be performed. Even in that case, the distribution of information to said partner may be an automated process.

### Scaling of Real-Time Operations and Cross-Jurisdictional Interaction

The 2^{nd} chance engine/platform is built to handle billions of submissions and actions on the site. Furthermore, a cross jurisdictional implementation allows operator/jurisdiction A to pool submissions with jurisdiction B, for example, for certain games, etc., per the n-permutation process described above. An exemplary cross jurisdictional implementation may be an inter-state 2^{nd} chance lottery program, where users in different states with their own state lotteries can purchase special tickets which can be entered on their separate websites, while the entries are pooled in a central database, i.e., a cross jurisdictional database.

Integration of 2^{nd} Chance Platform/Engine with Other Systems

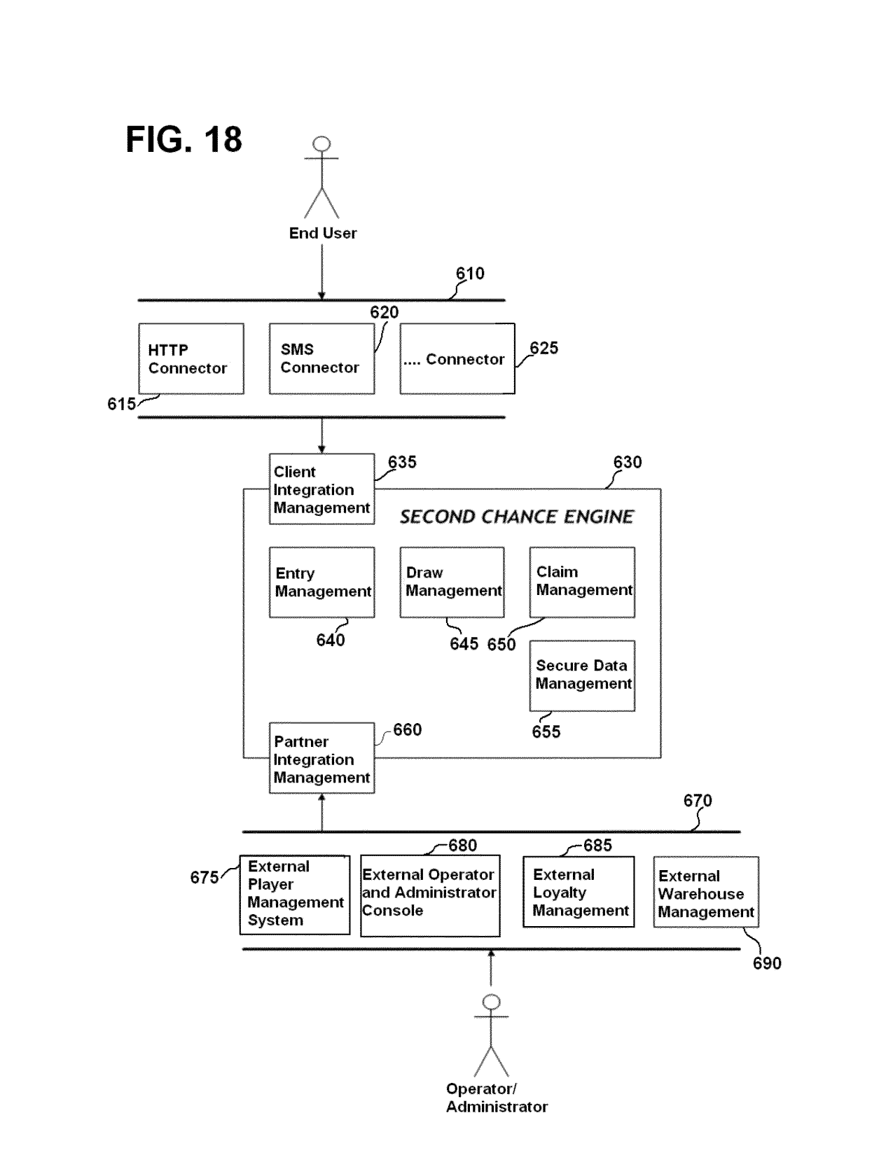

The 2^{nd} chance engine may be integrated with any 3^{rd} party player management system, loyalty engine or other engine. In an exemplary implementation, integration is implemented via secure API. FIG. 18 illustrates an exemplary block diagram in which the 2^{nd} chance engine is integrated with external systems.

As shown in FIG. 18, a 2^{nd} chance engine 630 is integrated with external user systems 610 controlled by an end user, and with external connected systems 670 supervised or controlled by an operator/administrator. The external user system 610 may be a device that connects to the Internet (“HTTP connector” 615), a device that can connect to a messaging service (“SMS connector” 620) or any other type of connecting device 625. The “HTTP connector” 615 may be a computer, server, network, mobile device having an Internet interface, such as cell phone, blackberry, IPad, etc. The SMS Connector 620 may be a messaging system such as, e.g., a cell phone. Any mobile, in store-closed linked, web enabled device such as, e.g., computer, mobile, tablet, Video terminal, Interactive TV, virtual glasses, etc., may be included in connector 620 or connecting device 625.

The 2^{nd} chance engine 630 includes a Client Integration Management unit 635, an Entry Management unit 640, a Draw Management unit 645, a Claim Management unit 650, a Secure Data Management unit 655 and a Partner Integration Management unit 660. 2^{nd} chance engine 630 integrates with any turnkey presentation software and/or media. All “end user” interaction with the 2^{nd} chance engine 630 may be via a generic, secure API, built on open standards and available across a range of architectures and programming languages. In this way it is possible to make submissions to the 2^{nd} chance engine 630 in a browser, natively in an app, or even through an SMS gateway, for example. Similarly, it is possible to view historical submissions, drawing entries, status of draws, etc., on the same platform.

The Client Integration Management unit 635 communicates with end-user devices, while the Partner Integration Management unit 660 communicates with one or more of an External Player Management System 675, an External Operator and Administrator Console 680, an External Loyalty Management unit 685 and an External Warehouse Management unit 690 which are under the supervision of one or more operators/administrators. Modules 635, 640, 645, 650, 655, 660, 675, 680, 685, 690 and the operations implemented by them may be implemented using standard gaming management system modules and applications. For example the ridjit platform may provide functionality to implement modules 635, 640, 645, 650, 655, 660, 675, 680, 685, 690 and their operations. Modules 635, 640, 645, 650, 655, 660, 675, 680, 685, 690 and their operations may also be specific or customized specifically for the present invention. For example, modules 635, 640, 645, 650, 655, 660, 675, 680, 685, 690 and their operations may be implemented as specialized modules and applications customized for a certain 2^{nd} chance gaming application or flow.

The Draw Management and Claim Management units 645 and 650 may be implemented using proprietary and pluggable draw and claim workflow engines designed with operators in mind. The workflows supporting the draw management and claim management processes may be built as standalone “machines”, in exemplary embodiments.

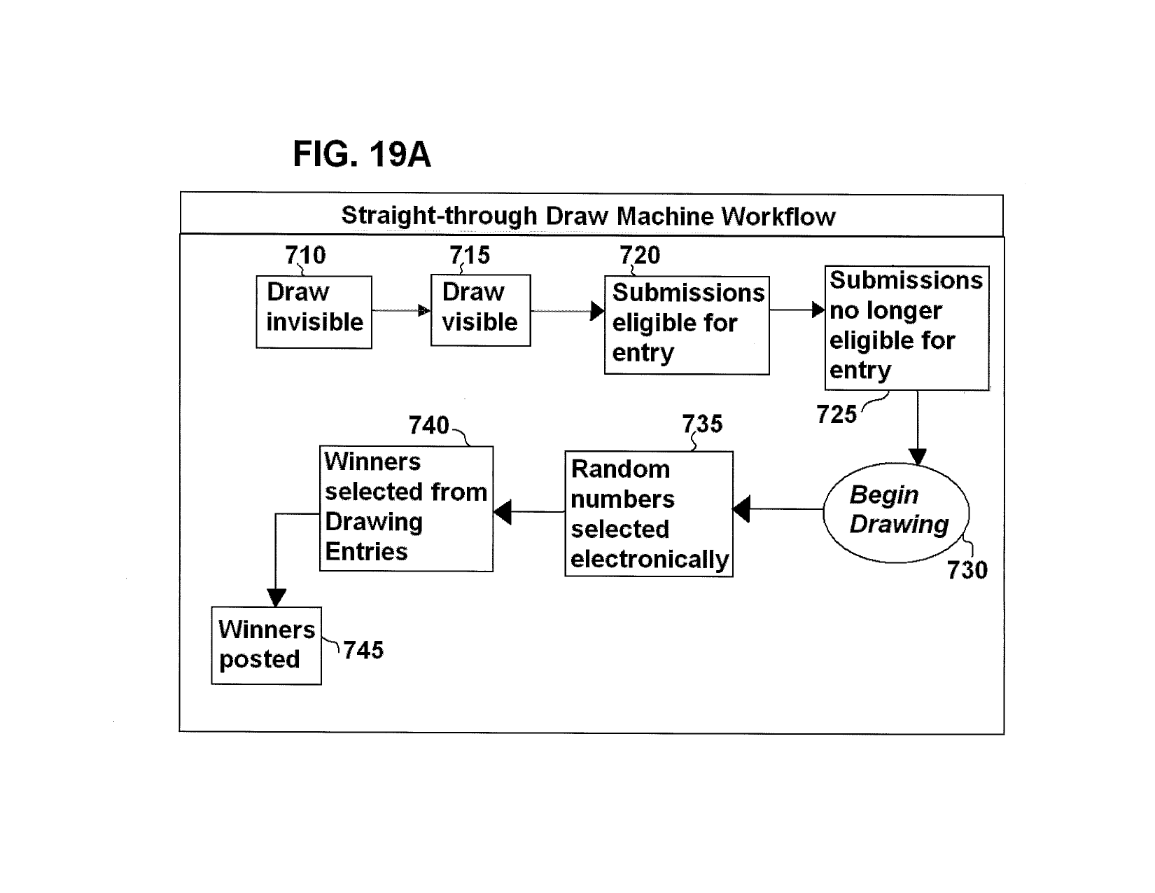

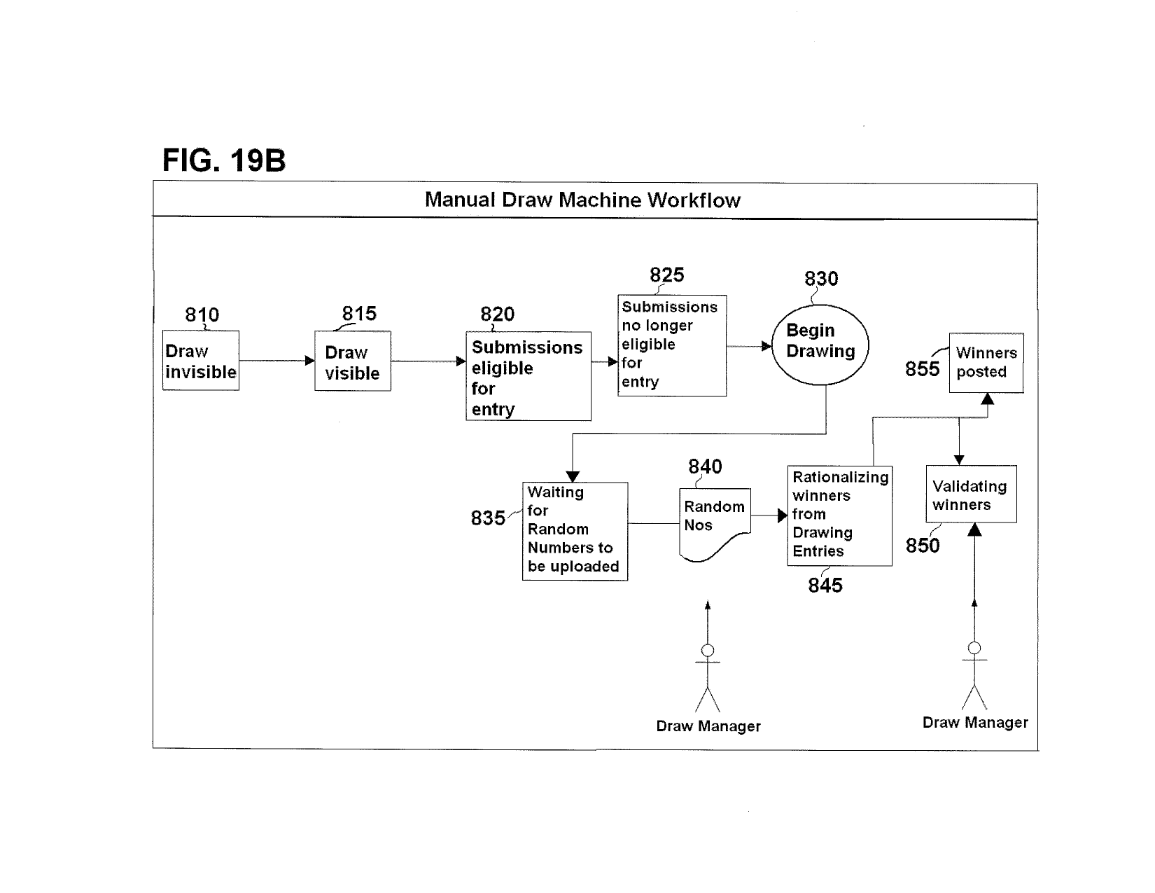

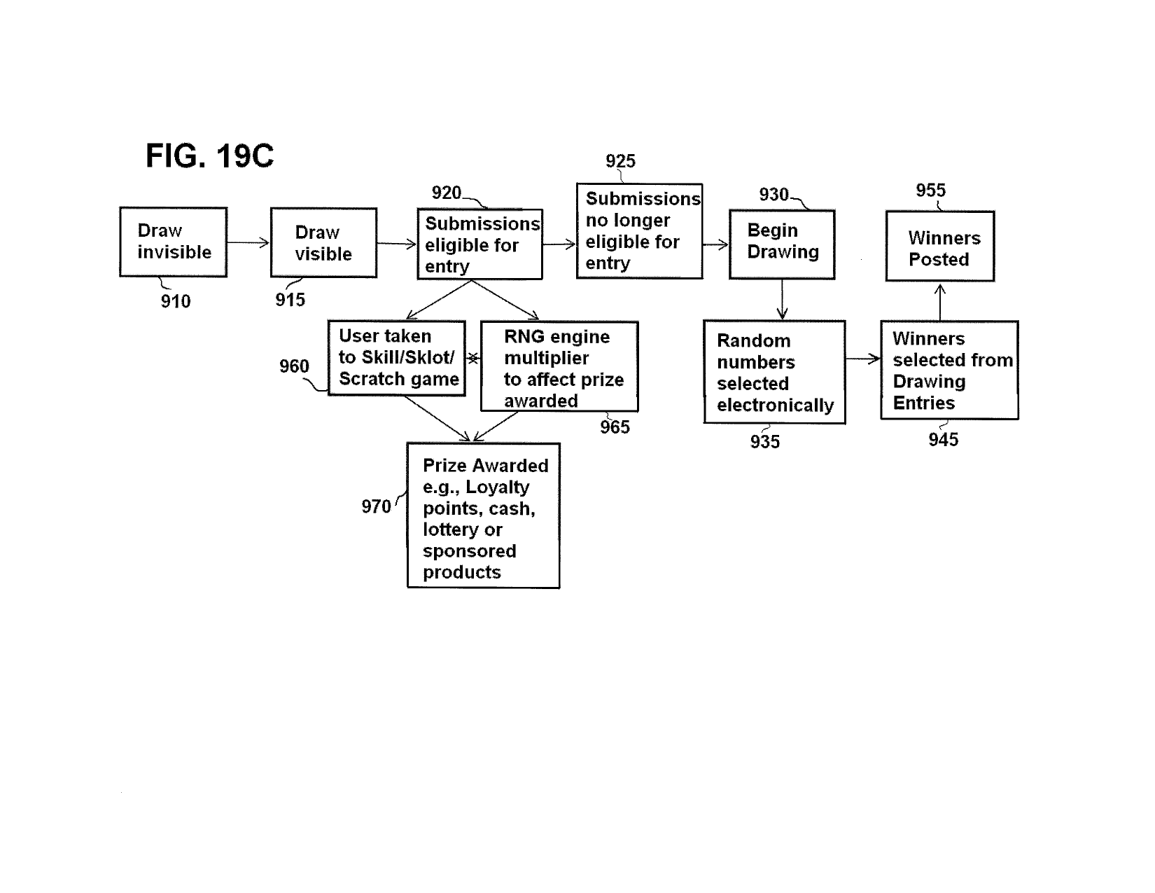

Generic machines that can implement the most common operator requirements may be used for units 645 and 650 of 2^{nd} chance engine 630. For example, a “straight through draw machine” and a “manual draw machine”, as shown in FIGS. 19A and 19B, respectively, can be used to implement these flows.

FIG. 19A illustrates a straight-through draw machine workflow for draw management in a 2^{nd} chance engine according to an embodiment of the present invention, and FIG. 19B illustrates a manual draw machine workflow for draw management in a 2^{nd} chance engine according to an embodiment of the present invention.

In an exemplary workflow, players who have entered a 2^{nd} chance draw are then shown an additional stage in the process where they interact with an RNG result/draw, RNG game, hybrid skill and chance game, and/or skill game, which then affects their winnings. The winnings can be affected by the player receiving a reward; the winnings may be a prize, additional entries into the allocated draws, entry into an additional draw, additional games for prizes, virtual prizes or money, etc. FIG. 19C illustrates in more detail machine workflows for draw management in a 2^{nd} chance engine according to an embodiment of the present invention.

In a straight-through draw machine workflow of the present invention shown in FIG. 19A, submissions eligible for entry (720) and those no longer eligible for entry (725) are identified and classified. The functions of the 710 and 715 flows in FIG. 19A are related to the ability to create draws at an advanced date. Such draws are then shown to customers on a web enabled device at a pre-determined time. To provide an example, this allows the system to show a new draw at midnight on an appointed day without manual or staff intervention at the start time. This allows continued operation of the system over holiday periods or out-of-office hours. When a drawing begins (730), random numbers are selected electronically (735), and winners are selected from drawing entries (740). Finally, winners are posted (745).

As shown in FIG. 19B, in a manual draw machine workflow of the present invention, submissions eligible for entry (820) and those no longer eligible for entry (825) are identified and classified. When a drawing begins (830), the machine waits for random numbers to be uploaded (835). A draw manager uploads random numbers (840), and the workflow then rationalizes winners from drawing entries (845). A draw manager validates the winners (850). The winners are thereafter posted (855).

In a machine workflow for draw management in a 2^{nd} chance engine illustrated in FIG. 19C, submissions eligible for entry (920) and those no longer eligible for entry (925) are entered into a drawing (930). In a submission eligible for entry (920), the user is taken to one or more 2^{nd} chance games such as a skill/sklot/scratch game(s) (960). An RNG engine multiplier may affect the prize awarded to the player (965). The prize awarded may be one or more of loyalty points, cash, lottery or sponsored products, etc. (970). In the drawing, random numbers are selected electronically (935), and winners are selected from the drawing entries (945). The winners are thereafter posted (955).

Thus, operators that wish to include 2^{nd} chance draw engines on their platform have the flexibility of choosing a stock/generic machine, if 2^{nd} chance is a new product in their portfolio. Differences between a stock or generic machine, and a specialized or customized 2^{nd} chance draw engine, in accordance with the present invention, are illustrated in FIG. 19C. The differences relate to the additional stages in the process relating to RNG and skill games/tournament and the influences of the RNG and skill games/tournament on loyalty points, winnings, and ticket entries for the 2^{nd} chance draw.

Or, if an operator is replacing a legacy 2^{nd} chance platform with a new one, the draw and claim management processes can remain status quo (virtually transparent to end user) to minimize operational risk at deployment time. A legacy system does not have links to additional mechanics to incentivize players and to add interactions and games, which make the process more fun, push players to spend more time on the site interacting with the brand, provide more time playing, and provide reasons to want to play more, and additionally reward 2^{nd} chance draw entries. The new system for replacing the legacy platform is linked to software RNG, skill games, tournament and other gaming mechanics that affect the interactions and prizes awarded to players, in accordance with the present invention.

The 2^{nd} chance engine of the present invention can employ near-unlimited storage capabilities. This can be achieved by using storage technology such as MongoDB or Cassandra for storage of hash codes and submissions. This allows keeping a single global instance of the 2^{nd} chance engine supporting unlimited jurisdictions, which would ease operations monitoring, troubleshooting, deployment of new systems, etc.

Whenever there is any activity in the context of the 2^{nd} chance engine, a notification event (with delta information related to the change as appropriate) may be fired to all interested parties, using an event bus derived in the 2^{nd} chance engine. This would allow for a more seamless integration with other product verticals.

Real-time aggregated statistics may also be derived. This may be achieved by computing every permutation of interesting data in near-time, so that players and operators can chop and change data (for example, using an Excel pivot table) without presenting significant load to database.

The present disclosure describes a 2^{nd} chance draw, engine, and flow which may be implemented and distributed on various gaming platforms, computing devices, and types of networks. When a player enters winning or losing tickets numbers on a 2^{nd} chance game interface via computer, mobile, terminal or other point of entry, winning ticket(s) are randomly be picked out using incentive software such as: RNG software; randomly generated multipliers on ticket entry which may be used to modify both the number of draw entries and loyalty points awarded to players; and n-permutation draw configurations, as described in the present invention. Furthermore, gaming that is not a 2^{nd} chance draw can award multipliers for a future 2^{nd} chance entry. The 2^{nd} chance draw may be implemented in a draw engine using software, hardware, or hybrid designs, and may be implemented to be fully automated from end-to-end, communicate between jurisdictions concerning 2^{nd} draw submissions on its interface, and may integrate with any 3^{rd} party player management system, loyalty engine, or other award system.

Although detailed embodiments and implementations of the present invention have been described above, it should be apparent that various modifications are possible without departing from the spirit and scope of the present invention. For example, while some of the methods, units and software applications above have been described above in the context of 2^{nd} chance draws on lottery websites, the principles of the current invention apply equally to 2^{nd} chance draws on any other platforms, or in-venue set-ups. Furthermore, combinations as well as one-way or two-way feedback between 2^{nd} chance draws and games which are not 2^{nd} chance draws, such as games of chance, slot, sklot and skill games, may be implemented in accordance with the flows and controls described in the present invention. Modifications and adaptations of the present invention will be apparent to those skilled in the art from consideration of the specification and practice of the invention disclosed herein.

The foregoing description of an implementation of the invention has been presented for purposes of illustration and description. It is not exhaustive and does not limit the invention to the precise form disclosed. Modifications and variations are possible in light of the above teachings or may be acquired from the practicing of the invention.

Additionally, although some aspects of the present invention are described for being stored in a memory, one skilled in the art will appreciate that these aspects can also be stored on other types of computer-readable media, such as secondary storage devices, for example, hard disks, floppy disks, or CD-ROM; the Internet or other propagation medium; or other forms of RAM or ROM.

We claim:

1. A gaming method, said method comprising:
providing to a player one or more second chance games based on participation in a first game of chance;
determining at least one benefit to be awarded to the player upon participation in the one or more second chance games; and
revealing to the player the at least one benefit,
wherein the method allows for entering said player into the one or more second chance games in said providing step.

2. The gaming method as recited in claim 1, wherein the method allows for a selection between at least one of
the one or more second chance games in said providing step, and
one or more benefits in said determining step.

3. The gaming method as recited in claim 2, wherein said selection between at least one of the one or more second chance games and one or more benefits is determined by the player.

4. The gaming method as recited in claim 2, wherein said selection between at least one of the one or more second chance games and one or more benefits is determined based on player's performance in a game.

5. The gaming method as recited in claim 2, wherein said selection between at least one of the one or more second chance games and one or more benefits is determined based on a type or value of a ticket used by the player in said providing step.

6. The gaming method as recited in claim 1, wherein said one or more second chance games is one or a combination of a prize draw, a scratcher, a skill game, a sklot game, an RNG game or other game of chance, and a slot game.

7. The gaming method as recited in claim 1, wherein said at least one benefit is one or more of cash, sponsored prize, loyalty point(s), lottery product, cash play entry, and value for buying a ticket to the second chance game.

8. The gaming method as recited in claim 1, the method further comprising:
checking an entry made by the player in said one or more second chance games in said providing step, to verify validity of the entry before said determining step.

9. The gaming method as recited in claim 1, wherein one or more multipliers affect at least one of
the number of draw entries provided to the player in the one or more second chance games, and
the at least one benefit to be awarded to the player.

10. The gaming method as recited in claim 9, wherein the one or more multipliers perform one or more of
modifying a game budget,
defining an extra benefit to be received from the multiplier,
modifying a draw,
modifying loyalty points to be awarded to the player,
modifying a game tournament entry, and
modifying VLT credits.

11. The gaming method as recited in claim 9, wherein the one or more multipliers are used as a random prize selector.

12. The gaming method as recited in claim 1, wherein a paytable from a plurality of paytables is selected in said determining step, to influence the at least one benefit to be awarded to the player upon participating in the one or more second chance games.

13. The gaming method as recited in claim 1, wherein an entry of the player into the one or more second chance games is multiplied by a number using a random number generator and a predetermined paytable which affects the at least one benefit to be awarded for the entry.

14. The gaming method as recited in claim 1, wherein a random draw entry multiplier is selected such that it generates on average a predetermined number of entries into the one or more second chance games per one ticket entered by the player in the one or more second chance games.

15. The gaming method as recited in claim 1, wherein
one or more multipliers is awarded based on a skill game previously played by the player, and
said one or more multipliers is applied to an entry of the player in said one or more second chance games,
said one or more multipliers influencing said at least one benefit to be awarded to the player.

16. The gaming method as recited in claim 1, wherein an n-permutation draw configuration is presented to the player in the one or more second chance games.

17. The gaming method as recited in claim 1, the method further comprising:
pooling, between multiple jurisdictions, at least one of player entries and awarded benefits.

18. A gaming machine, said machine comprising:
at least one processor, wherein said at least one processor
provides to a player one or more second chance games based on participation in a first game of chance,
determines at least one benefit to be awarded to the player upon participating in the one or more second chance games, and
reveals to the player the at least one benefit,
wherein said at least one processor allows for entering said player into the one or more second chance games.

19. The gaming machine as recited in claim 18, wherein said at least one processor allows for a selection between at least one of
the one or more second chance games, and
one or more benefits.

20. The gaming machine as recited in claim 19, wherein said selection between at least one of the one or more second chance games and one or more benefits is determined by the player.

21. The gaming machine as recited in claim 19, wherein said selection between at least one of the one or more second chance games and one or more benefits is determined based on player's performance in a game.

22. The gaming machine as recited in claim 19, wherein said selection between at least one of the one or more second chance games and one or more benefits is determined based on a type or value of a ticket used by the player to enter the one or more second chance games.

23. The gaming machine as recited in claim 18, wherein said one or more second chance games is one or a combination of a prize draw, a scratcher, a skill game, a sklot game, an RNG game or other game of chance, and a slot game.

24. The gaming machine as recited in claim 18, wherein said at least one benefit is one or more of cash, sponsored prize, loyalty point(s), lottery product, cash play entry, and value for buying a ticket to the one or more second chance games.

25. The gaming machine as recited in claim 18, wherein one or more multipliers associated with said at least one processor affect at least one of
the number of draw entries provided to the player in the one or more second chance games by said at least one processor, and
the at least one benefit determined by said at least one processor.

26. The gaming machine as recited in claim 25, wherein said at least one processor uses the one or more multipliers to perform one or more of
modifying a game budget,
defining an extra benefit to be received from the multiplier,
modifying a draw,
modifying loyalty points to be awarded to the player,
modifying a game tournament entry, and
modifying VLT credits.

27. The gaming machine as recited in claim 25, wherein the one or more multipliers are used as a random prize selector.

28. The gaming machine as recited in claim 18, wherein said at least one processor selects a paytable from a plurality of paytables to influence the at least one benefit to be awarded to the player upon participating in the one or more second chance games.

29. The gaming machine as recited in claim 18, wherein said at least one processor multiplies an entry of the player into the one or more second chance games by a number using a random number generator and a predetermined paytable which affects the at least one benefit to be awarded for the entry.

30. The gaming machine as recited in claim 18, wherein said at least one processor selects a random draw entry multiplier such that on average a predetermined number of entries are generated into the one or more second chance games per one ticket entered by the player in the one or more second chance games.

31. The gaming machine as recited in claim 18, wherein
said at least one processor awards one or more multipliers based on a skill game previously played by the player, and
said at least one processor applies said one or more multipliers to an entry of the player in the one or more second chance games, said one or more multipliers influencing said at least one benefit to be awarded to the player.

32. The gaming machine as recited in claim 18, wherein said at least one processor presents to the player an n-permutation draw configuration in the one or more second chance games.

33. The gaming machine as recited in claim 18, said at least one processor further pooling, between multiple jurisdictions, at least one of player entries and awarded benefits.

34. The gaming machine as recited in claim 18, wherein at least one of
the one or more second chance games,
said first game of chance, and
determination of said at least one benefit
is implemented by said at least one processor using an application programming interface (API) flash container solution.

35. The gaming machine as recited in claim 18, wherein said at least one processor includes a pluggable database architecture.

36. A gaming system comprising:
an engine for playing one or more second chance games;
a first connector device for interfacing between the engine and a device of a player; and
a second connector device for interfacing between the engine and a 3^{rd} party system, the 3^{rd} party system being configured to manage at least one of participation in said one or more second chance games and benefits to be awarded for playing said one or more second chance games,
wherein the engine and connector devices are programmed to operate so that:
the engine provides to the player one or more second chance games based on participation in a first game of chance, and determines at least one benefit to be awarded to the player upon participating in the one or more second chance games,
the first connector device enables the player to enter the one or more second chance games, and
the second connector device integrates the engine with the 3^{rd} party system.

37. The gaming system as recited in claim 36, wherein the engine is integrated with the 3^{rd} party system via secure API.

38. The gaming system as recited in claim 36, wherein the engine is a straight through draw machine, or a manual draw machine.

39. The gaming system as recited in claim 36, wherein the engine derives an event bus.

40. The gaming system as recited in claim 36, wherein
said one or more second chance games is one or a combination of a prize draw, a scratcher, a skill game, a sklot game, an RNG game or other game of chance, and a slot game, and
said at least one benefit is one or more of cash, sponsored prize, loyalty point(s), lottery product, cash play entry, and value for buying a ticket to the second chance game.
